(19) United States
(12) Patent Application Publication
(10) Pub. No.: US 2002/0112075 A1
(43) Pub. Date: Aug. 15, 2002

(54) Relay apparatus

(75) Inventors: Yoshihiro Takashimizu, Kawasaki (JP); Keiji Ishiguro, Kawasaki (JP)

Correspondence Address: ARMSTRONG,WESTERMAN & HATTORI, LLP, 1725 K STREET, NW., SUITE 1000, WASHINGTON, DC, 20006, US

(73) Assignee: Fujitsu Limited, Kawasaki (JP)

(21) Appl. No.: 09/891,387

(22) Filed: Jun. 27, 2001

(30) Foreign Application Priority Data
Jan. 26, 2001 (JP) 2001-018247

(51) Int. Cl. G06F 15/173

(52) U.S. Cl. 709/244; 709/224

(57) ABSTRACT

A relay apparatus is connected to a host computer through a network and transmits data received from the host computer to a device. A first basic unit and a second basic unit are provided for the relay apparatus. A common network address is set into the first and second basic units. The relay apparatus performs a relay control between the host computer and the device. A common unit makes one of the first and second basic units operative as a present system and monitors its status. When an abnormality is detected during the monitoring operation, the relay apparatus stops the basic unit of the present system and switches it to the operation of the basic unit of a standby system.

### BACKGROUND OF THE INVENTION

1. Field of the Invention

The invention relates to a relay apparatus which is connected to a host computer through a network and transmits data received from the host computer to a device such as display, printer, or the like and, more particularly to a relay apparatus in which a host computer of the present system and a host computer of the standby system have a duplex structure.

2. Description of the Related Arts

In recent years, there has been known a system such that a host computer and devices such as displays, printers, and the like are connected by a network such as line, wide-area IAN (Local Area Network), or the like and data is transmitted from the host computer and displayed or printed in response to a request from the device side. In such a system, in the case where a distance between the host computer and the device is long, a relay apparatus is provided on the device side.

FIG. 1 shows an example of a conventional system. A host computer 200 and a relay apparatus 204 are connected through a network 202 such as line, LAN, or the like. A host communication control unit 206, a main control unit 208, an LAN communication control unit 210, and a coaxial communication control unit 212 are provided for the relay apparatus 204. The LAN communication control unit 210 of the relay apparatus 204 connects devices 216-1 to 216-32 such as display, printer, and the like through an LAN 214. The coaxial communication control unit 212 of the relay apparatus connects devices 220-1 to 220-32 such as display, printer, and the like through coaxial cables 218-1 to 218-32. The relay apparatus 204 receives data requested from the device side from the host computer 200 and transmits it to the device on the requesting source side, thereby enabling an interactive communication to be realized between the host computer 200 and the device. In many use forms, the host computer 200 and relay apparatus 204 are connected by a relatively remote network and the relay apparatus 204 and the device side are connected by a local network. By connecting the host computer 200 and the device by using the relay apparatus 204 as mentioned above, as compared with a case where the device side is directly connected to the host computer, there are advantages such that the number of lines between the host computer and the devices can be reduced and the host computer and the devices can be connected by a cheap network.

The host computer 200 has a corresponding table 222 for the host in FIG. 2A. The relay apparatus 204 has a corresponding table 224 for the relay apparatus in FIG. 2B. The corresponding table 222 for the host is constructed by device numbers 0 to n and relay apparatus addresses. For example, in case of using a line as a network 202, since an IP protocol is used as a host connecting protocol, the relay apparatus address is set to, for example, (10.1.1) as an IP address. The corresponding table 224 for the relay apparatus is constructed by device numbers 0 to n and device addresses. For example, in case of using an LAN 214, the device addresses are specified by subnets subsequent to the IP addresses and set to, for example, (10.1.1.0) to (10.1.1.n). Therefore, the host computer 200 recognizes the relay apparatus address with reference to the corresponding table 222 for the host by the device number in response to a request from a certain device and transmits data. The relay apparatus 204 which received the data from the host computer 200 recognizes the device address with reference to the corresponding table 224 for the relay apparatus by the device number and transmits the data to the device on the requesting source side.

FIGS. 3A and 3B show a basic business system using the conventional system in FIG. 1 and it has a duplex structure in order to prevent a system-down. According to the duplex structure, a host computer 200-1 of the present system and a host computer 200-2 of the standby system are provided and a relay apparatus 2041 of the present system and a relay apparatus 204-2 of the standby system are connected through the network 202. With respect to the device side, with regard to the devices 216-1 to 216-32 which have a 1-to-n connecting relationship and are connected to the LAN 214 of the relay apparatus 204-1 of the present system, the relay apparatus 204-2 of the standby system can be used in common. However, with regard to the devices 220-1 to 220-32 which have a 1-to-1 connecting relationship and are connected by the coaxial cables 218-1 to 218-32, since the relay apparatus 204-2 of the standby system cannot be used in common, dedicated devices 222-1 to 222-32 for the standby system are prepared and connected by coaxial cables 228-1 to 228-32. The structure such that the devices are duplexed as a present system and a standby system causes an increase in redundancy of a system configuration and causes a scale of the whole system to be increased unnecessarily. To prevent such a drawback, therefore, as shown in FIGS. 4A and 4B, there is also a system such that the devices 220-1 to 220-32 are used in common for the present system and the standby system by providing a coaxial switching mechanism 226.

However, the system using such conventional relay apparatuses with the duplex structure as mentioned above has the following problems. First, since the duplex structure is formed by individually connecting the relay apparatuses 204-1 and 204-2 to the host computers 200-1 and 200-2 of the present system and standby system, it is necessary to assure peculiar network addresses, for example, IP addresses (10.1.1) and (10.1.2) for the relay apparatuses 2041 and 204-2, respectively, so that line costs increase. Particularly, with respect to the standby system, a use efficiency of the line is extremely low and there is a problem such that the line which is hardly used has to be assured. In the host computers 200-1 and 200-2 and relay apparatuses 204-1 and 204-2 of the present system and standby system, it is necessary to prepare a table that is peculiar to each system as each corresponding table in FIGS. 2A and 2B. There is a problem such that the tables are complicated and their sizes are also large. When the use computer is switched from the host computer 200-1 of the present system to the host computer 200-2 of the standby system or when it is automatically switched due to a failure, there is a problem such that it is impossible to cope with the automatic switching from the relay apparatus 204-1 to the relay apparatus 204-2, active maintenance in which the use of a substitute destination as a present system is continued and which is executed in parallel with the maintenance work for recovery, and further, the control in association with the active maintenance.

In the relay apparatuses 204-1 and 204-2 to which the devices 220-1 to 220-32 which are connected by the coaxial cables in FIGS. 3A and 3B are connected through the coaxial switching mechanism 226, when the relay is switched from the relay apparatus 204-1 of the present system to the relay apparatus 204-2 of the standby system by the coaxial switching mechanism 226, it takes time to a certain extent until the detection of the occurrence of a fault in the relay apparatus 204-1 is confirmed, the operator or maintenance person turns off a power source of the relay apparatus 204-1 of the present system, stops the operation thereof, switches the coaxial switching mechanism 226 to the standby system, thereafter, turns on a power source of the relay apparatus 204-2 of the standby system, and activates the operation thereof. There is a risk that, for such a period of time, a device error occurs in the host computer 200-2 of the standby system which is operating as a substitute and the system stops. Further, in the relay apparatus 204-1 of the present system, although set information and resource information of the devices 220-1 to 220-32 for a coaxial communication control unit 212-1 have been registered and preserved in the apparatus, in case of the switching due to the fault or the like of the relay apparatus 204-1, information resources necessary for a relay control cannot be taken over from the relay apparatus 204-1 to the relay apparatus 204-2 of the standby system. It is necessary that the operator reinputs or downloads the information resources.

### SUMMARY OF THE INVENTION

According to the invention, a relay apparatus having a duplex structure of a high line use efficiency in which it is sufficient to use one network address is provided.

According to the invention, a relay apparatus which automatically switches duplexed relay functions is also provided.

Further, according to the invention, a relay apparatus which can select duplexed relay functions and select duplexed host computers in accordance with the input instructing operation is provided.

According to the invention, there is provided a relay apparatus which is connected to a host computer through a network and transmits data received from the host computer to a device, comprising: a first basic unit to which a peculiar network address is set and which performs a relay control between the host computer and the device; a second basic unit to which the same network address as that of the first basic unit is set and which performs a relay control between the host computer and the device; and a common unit which makes one of the first basic unit and the second basic unit operative as a present system and monitors its status, and when an abnormality is detected during the monitoring, stops the basic unit of the present system and switches it to the operation of the basic unit of a standby system. Even if the relay function is duplexed by the first basic unit and the second basic unit as mentioned above, since the common network address is set, it is sufficient to use only one network connection by the line or LAN to the host computer irrespective of the duplexed structure. The line can be efficiently used and line costs can be reduced. In case of a system configuration such that the host computers of the present system and standby system are arranged, since each host computer is connected to the relay apparatus by using the common relay apparatus address, it is unnecessary that the host computer is aware of the duplex structure of the relay apparatus and it is sufficient to perform a data communication with the single relay apparatus. Therefore, a communication control can be simplified. Since common information can be used as set information such as a device corresponding table or the like, it can be also simplified. A status of the basic unit of the present system is monitored by the common unit and, when an abnormality is detected, the basic unit of the present system is automatically switched to the basic unit of the standby system, and such a switching operation can be promptly performed. Therefore, a system stop due to a device error does not occur on the host computer side during the switching. The common network address which is used in the basic units is preserved in the common unit. Upon switching of the basic units, the common network address is transmitted from the common unit to the basic unit on the switching destination side, and a communication control with the host computer is activated. Therefore, even if the automatic switching is performed when a fault occurs in the basic unit, the network address of the basic unit in which the fault occurred can be certainly taken over to the basic unit on the switching destination side.

Each of the first and second basic units comprises: a host communication control unit which is connected to the host computer and communicates therewith; a device communication control unit which is connected to the device and communicates therewith; a main control unit which performs a relay control for relaying data received from the host computer to the device; a setting unit which inputs set information necessary for relaying; a secondary storing unit which stores resources including the set information, a control program, and a character pattern which is supplied from the host computer; and a status monitoring unit which periodically notifies the common unit of a self status obtained as a self diagnosis result. The common unit comprises: a common unit interface which is connected to the first basic unit and the second basic unit and communicates therewith; a common unit address unit using a non-volatile memory for storing a common network address which is used for the first and second basic units; and an abnormality detecting unit which, when an abnormality is detected from a status notice of the basic unit of the present system, instructs a power-off of the basic unit of the present system, thereafter, instructs a power-on of the basic unit of the standby system, and further, transmits the common network address stored in the common unit address unit to the host communication control unit of the basic unit of the standby system, thereby allowing it to be taken over. As mentioned above, a principal function of the relay control in which a possibility of the occurrence of an error is relatively high is arranged into the basic unit and an abnormality detecting function and a storing function of the network address in which there is hardly a risk of the occurrence of an error are arranged into the common unit, thereby improving the reliability of the relay apparatus itself with the duplex structure of the invention.

The abnormality detecting unit of the common unit has a timer which sets a set time and is reactivated each time the periodic status notice from the basic unit is received, and detects the abnormality of the basic unit of the present system from a time-out of the timer. Therefore, when the basic unit causes a system-down and no status notice is received, the abnormality is detected and the switching for backup can be certainly performed. When the common network address cannot be received from the common unit upon activation by the power-on, the host communication control unit of each of the first and second basic units reads out the common network address stored in a self address ROM and sets it. Therefore, even if a situation such that the common network address is not transmitted from the common unit to the basic unit on the switching destination side is caused due to the fault, the control unit can be certainly activated by using the network address stored in its own unit. The common unit has a processing system selecting switch which selects the basic unit serving as a present system. In response to a notification of the power-on operation from the first or second basic unit, the common unit interface instructs a power-off to the basic unit of the present system and, thereafter, instructs a power-on to the basic unit selected by the processing system selecting switch. Each of the first and second basic units has a power control unit which notifies the common unit of the power-on operation at the time of the turn-on operation of a power switch, turns on a self power source when the power-on instruction is received from the common unit, and turns off the self power source when a power-off instruction is received from the common unit. Thus, upon activation at the time when the use of the basic unit is started or upon reactivation in association with a recovery of the fault, the operator or maintenance person can select the basic unit by the switch and activate it.

When the host computer of the present system and the host computer of the standby system are arranged through the network, the first and second basic units store the set information of the host computer of the present system and the host computer of the standby system into the secondary storing units. The common unit has a host selecting switch which instructs the selection of the host computer of the present system or the host computer of the standby system and makes a response of a selecting instruction of the host selecting switch in response to the notice of the power-on operation from the first or second basic unit. The basic unit which received the power-on instruction from the common unit is initialized by the set information of the host computer to which the selection was instructed and starts the relay operation. Therefore, upon activation in association with the power-on of the relay apparatus, a specific one of a plurality of host computers can be selected as a present system and the relay control can be started on the relay apparatus side. A plurality of devices such as displays and/or printers and the like are connected to the device communication control units of the first and second basic units by a common local area network. A plurality of devices such as displays and/or printers and the like are individually connected to the device communication control units of the first and second basic units by coaxial lines through a coaxial switching mechanism. Further, a coaxial communication control unit which connects a plurality of devices such as displays and/or printers and the like by the coaxial lines can be also connected to the device communication control units of the first and second basic units through the common local area network.

According to another embodiment of the invention, there is provided a relay apparatus which is connected to a host computer of the present system or a host computer of the standby system through a network and transmits data received from the host computer in the connecting relation to a device, comprising: a basic unit into which a peculiar network address is set and which performs a relay control between the host computer of the present system or the host computer of the standby system and the device; and a common unit which instructs the basic unit to select the host computer of the present system or the host computer of the standby system and activates the selected host computer. In the case where only one basic unit is provided for the relay apparatus as mentioned above, when the relay apparatus is activated by a power-on, the basic unit of the relay apparatus using the set information of the host computer whose selection was artificially instructed is activated, and the host computer connected to the relay apparatus can be easily selected as necessary. The basic unit comprises: a power control unit which notifies the common unit of the power-on operation at the time of the turn-on operation of a power switch and, thereafter, turns on a power source; a secondary storing unit which stores resources including set information of the host computer of the present system and the host computer of the standby system; a host communication control unit which is initialized by the set information of the host computer whose selection was instructed from the common unit, is connected to the host computer, and communicates therewith; a device communication control unit which is connected to the device and communicates therewith; and a main control unit which performs a relay control for relaying data received from the host computer to the device. In this case, the common unit comprises: a host selecting switch which instructs a selection of the host computer of the present system or the host computer of the standby system; and a common unit interface which is connected to the basic unit, communicates therewith, and responds a selecting instruction of the host computer by the host selecting switch in response to a notice of the power-on operation from the basic unit.

The above and other objects, features, and advantages of the present invention will become more apparent from the following detailed description with reference to the accompanying drawings.

### BRIEF DESCRIPTION OF THE DRAWINGS

FIG. 1 is a block diagram of a conventional system using a relay apparatus;

FIGS. 2A and 2B are explanatory diagrams of a host corresponding table and a relay apparatus corresponding table which are used in FIG. 1;

FIGS. 3A and 3B are block diagrams of a duplex structure system using the conventional system of FIG. 1;

FIGS. 4A and 4B are block diagrams of a duplex structure system in which coaxial device connections in FIGS. 3A and 3B are made common by a switching mechanism;

FIG. 5 is a block diagram of a hardware construction of a system using a relay apparatus of the invention;

FIGS. 6A and 6B are detailed block diagrams of the hardware construction of the system using the relay apparatus of the invention;

FIGS. 7A and 7B are block diagrams of a system of a functional construction of the relay apparatus of the invention;

FIG. 8 is an explanatory diagram of host set information which is stored in basic units of relay apparatuses in FIGS. 4A and 4B;

FIGS. 9A to 9F are flowcharts for an automatic switching process in the case where an abnormality of the basic unit is detected;

FIGS. 10A to 10D are flowcharts for a basic unit switching process according to the manual operation;

FIGS. 11A to 11E are flowcharts for a host switching process according to the manual operation;

FIGS. 12A and 12B are block diagrams of a hardware construction of a system using the relay apparatus of the invention having an expanded structure of a coaxial connecting device;

FIGS. 13A and 13B are block diagrams of a hardware construction of a system using the relay apparatus of the invention having a construction such that the host is manually switched; and

FIGS. 14A and 14B are block diagrams of a functional construction of the relay apparatus in FIGS. 13A and 13B.

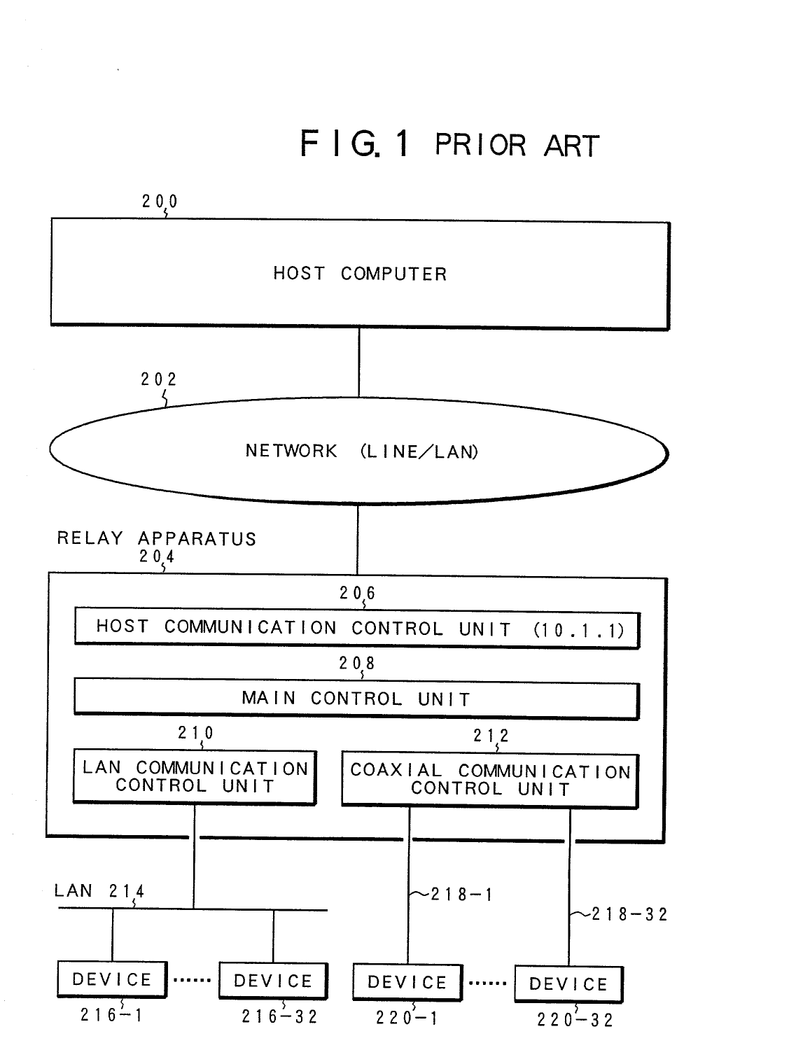

### DETAILED DESCRIPTION OF THE PREFERRED EMBODIMENTS

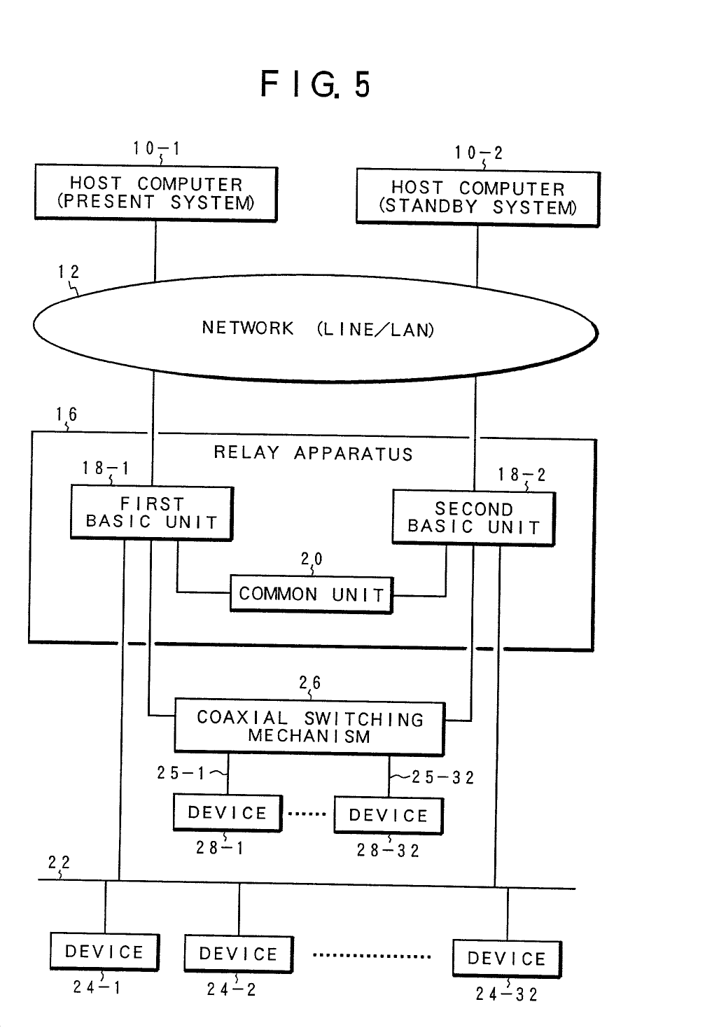

FIG. 5 is a block diagram of a hardware construction of a computer system using a relay apparatus of the invention. A relay apparatus 16 of the invention is connected to a host computer 10-1 of the present system and a host computer 10-2 of the standby system through a relatively remote network 12 such as line, LAN, or the like. As for the transmission and reception of data between the host computers 10-1 and 10-2 and relay apparatus 16, in case of using the line as a network 12, a connection using an IP address is made by an IP protocol. In case of using the LAN as a network 12, a connection using an LAN address which is used in an LAN protocol is made. The relay apparatus 16 of the invention comprises a first basic unit 18-1, a second basic unit 18-2, and a common unit 20. The first basic unit 18-1 corresponds to, for example, the host computer 10-1 of the present system, the second basic unit 18-2 corresponds to the host computer 10-2 of the standby system, and they have the same hardware construction. Devices 24-1 to 2432 such as 32 printers, displays, and the like are connected to the basic units 18-1 and 18-2 provided for the relay apparatus 16 by an LAN 22. Devices 28-1 to 28-32 such as displays, printers, and the like are similarly connected to the first basic unit 18-1 and second basic unit 18-2 through a coaxial switching mechanism 26 by coaxial cables 25-1 to 25-32.

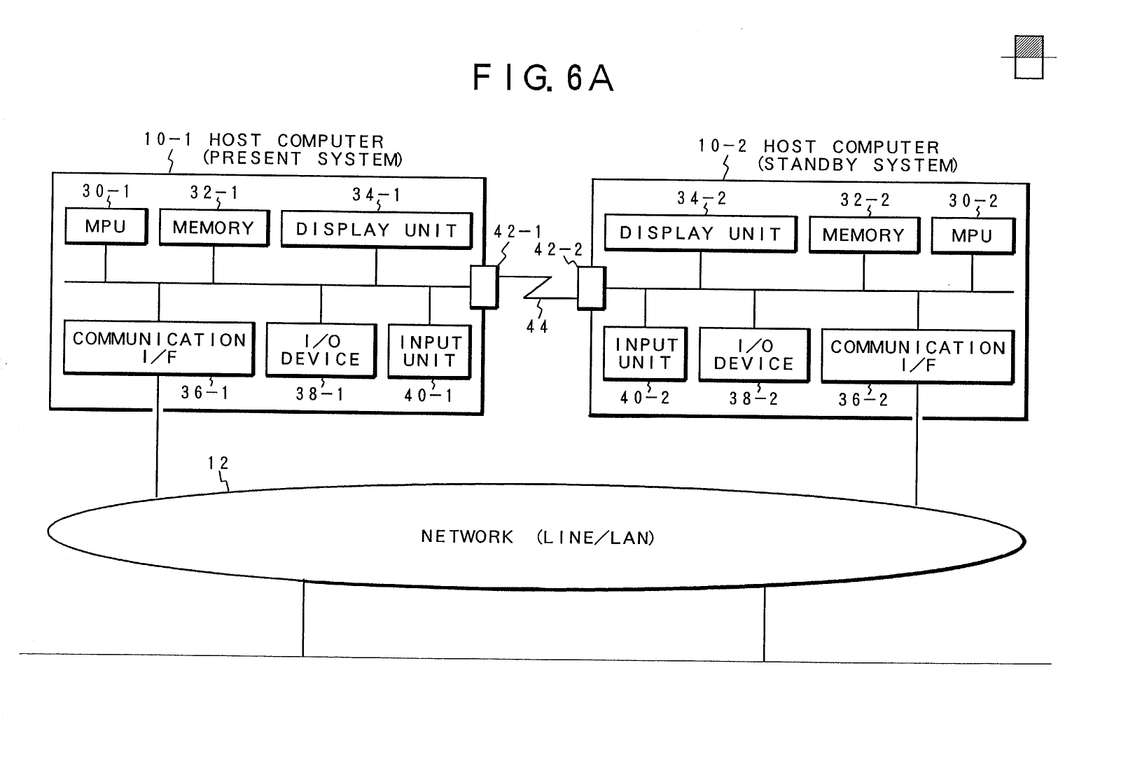

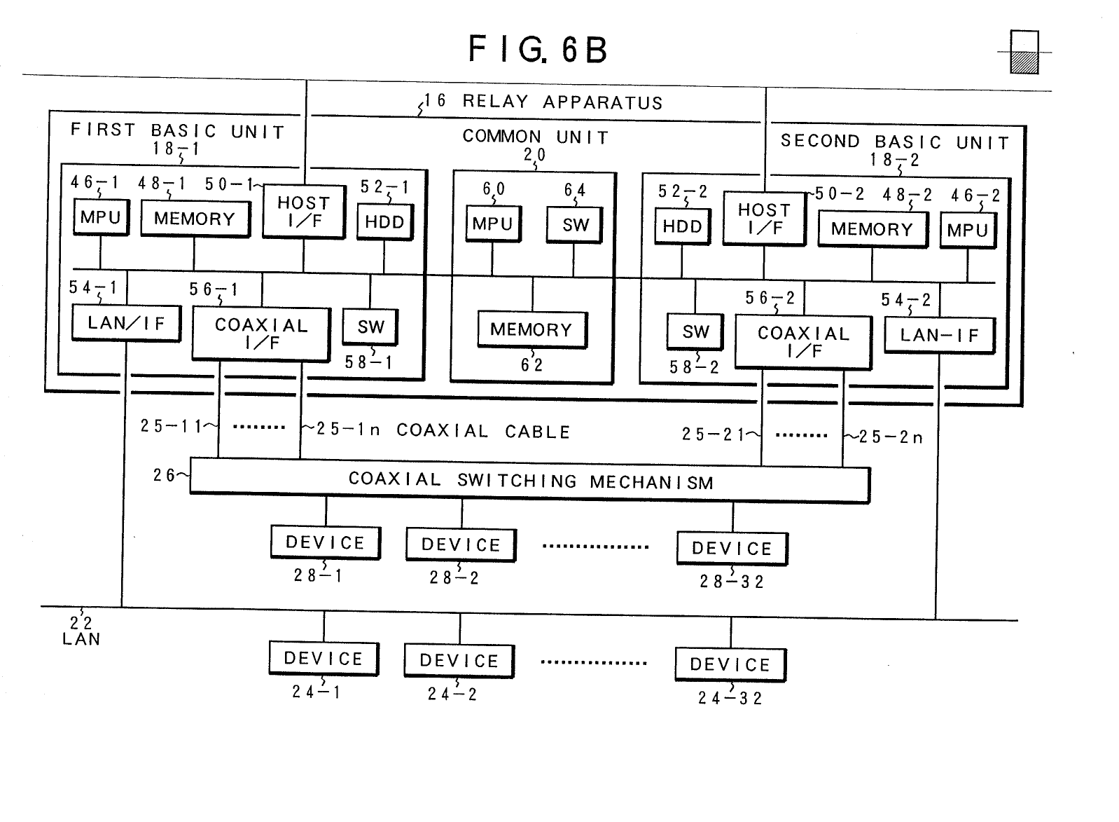

FIGS. 6A and 6B show the details of the hardware construction of FIG. 5. The host computer 10-1 of the present system comprises: an MPU 30-1; a memory 32-1; a display unit 34-1; a communication interface unit 36-1; an input/output device 38-1 such as HDD, floppy disk, printer, etc.; and an input unit 40-1 such as keyboard, mouse, etc. The host computer 10-2 of the standby system also has a construction similar to that mentioned above, that is, the host computer 10-2 also comprises: an MPU 30-2; a memory 32-2; a display unit 34-2; a communication interface unit 36-2; an input/output device 38-2; and an input unit 40-2. A connection by a dedicated line 44 is made to the host computers 10-1 and 10-2 by using communication interface units 42-1 and 42-2.

The first basic unit 18-1 of the relay apparatus 16 of the invention comprises: an MPU 46-1; a memory 48-1; a host interface unit 50-1; an HDD 52-1 which functions as a secondary storing unit; an LAN interface unit 54-1; a coaxial interface unit 56-1; and a switch unit 58-1. The second basic unit 18-2 also has a hardware construction similar to that mentioned above. That is, the second basic unit 18-2 comprises: an MPU 46-2; a memory 48-2; a host interface unit 50-2; an HDD 52-2; an LAN interface unit 54-2; a coaxial interface unit 56-2; and a switch unit 58-2. The LAN 22 which connects the devices 24-1 to 24-32 is connected to the LAN I/F units 54-1 and 54-2 of the first basic unit 18-1 and second basic unit 18-2, respectively. The coaxial switching mechanism 26 is connected to the coaxial I/F units 56-1 and 56-2 of the first basic unit 18-1 and second basic unit 18-2, respectively. In an operating mode of the first basic unit 18-1 corresponding to the host computer 10-1 of the present system, the coaxial switching mechanism 26 connects the devices 28-1 to 28-32 to the coaxial I/F unit 56-1. On the other hand, in an operating mode of the second basic unit 18-2 corresponding to the host computer 10-2 of the standby system, the coaxial switching mechanism 26 switches the devices 28-1 to 28-32 to the coaxial I/F unit 56-2 side.

The common unit 20 of the relay apparatus 16 comprises an MPU 60; a memory 62; and a switch unit 64. Most of a hardware amount of the relay apparatus 16 is allocated to the first basic unit 18-1 and second basic unit 18-2. A hardware amount of the common unit 20 is suppressed to the necessary minimum amount. A network address for transmitting and receiving data by connecting to the host computers 10-1 and 10-2 through the network 12 is managed by the common unit 20. Ordinarily, the first basic unit 18-1 corresponding to the host computer 10-1 of the present system is in the operating mode. The network address allocated to the relay apparatus 16 is set into the first basic unit 18-1, thereby making a connection to the host computer 10-1 by the host I/F unit 50-1. If a fault occurs in the first basic unit 18-1, this unit is automatically switched to the second basic unit 18-2. In this case, however, the same network address managed by the common unit 20 is also set into the host I/F unit 50-2 and taken over. That is, although the relay apparatus 16 of the invention has relay control mechanisms which are independent also in a hardware manner such as first basic unit 18-1 and second basic unit 18-2, a common address is used as a network address for making a connection to the sides of the host computers 10-1 and 10-2.

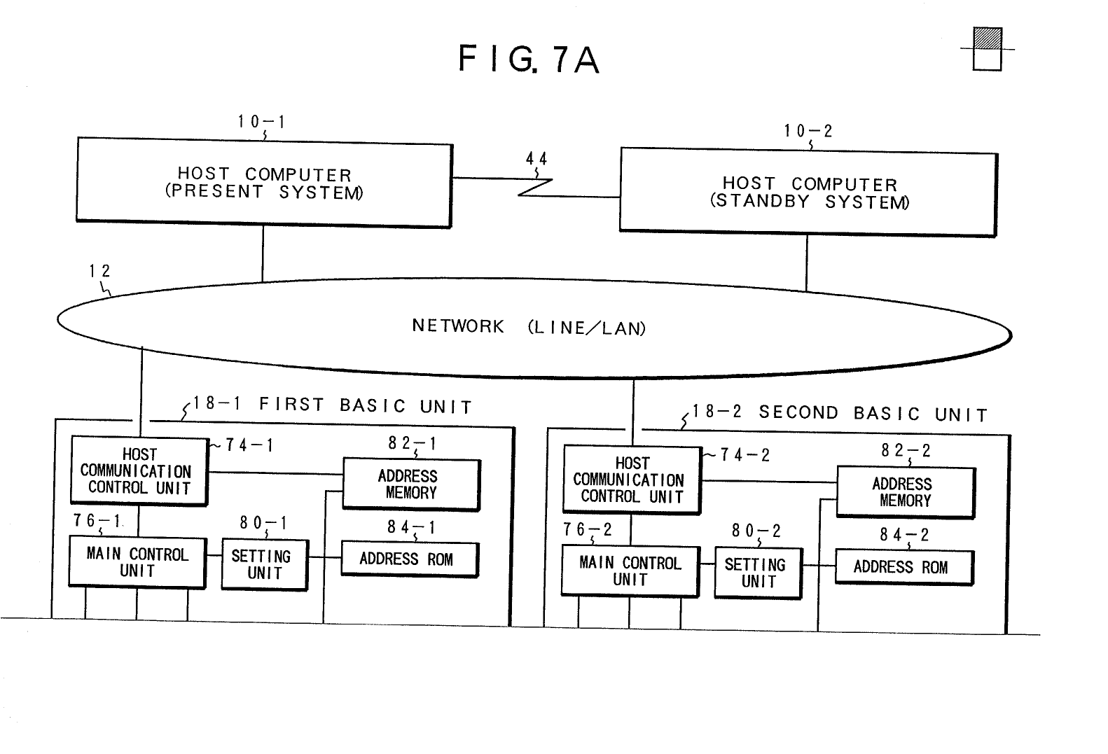

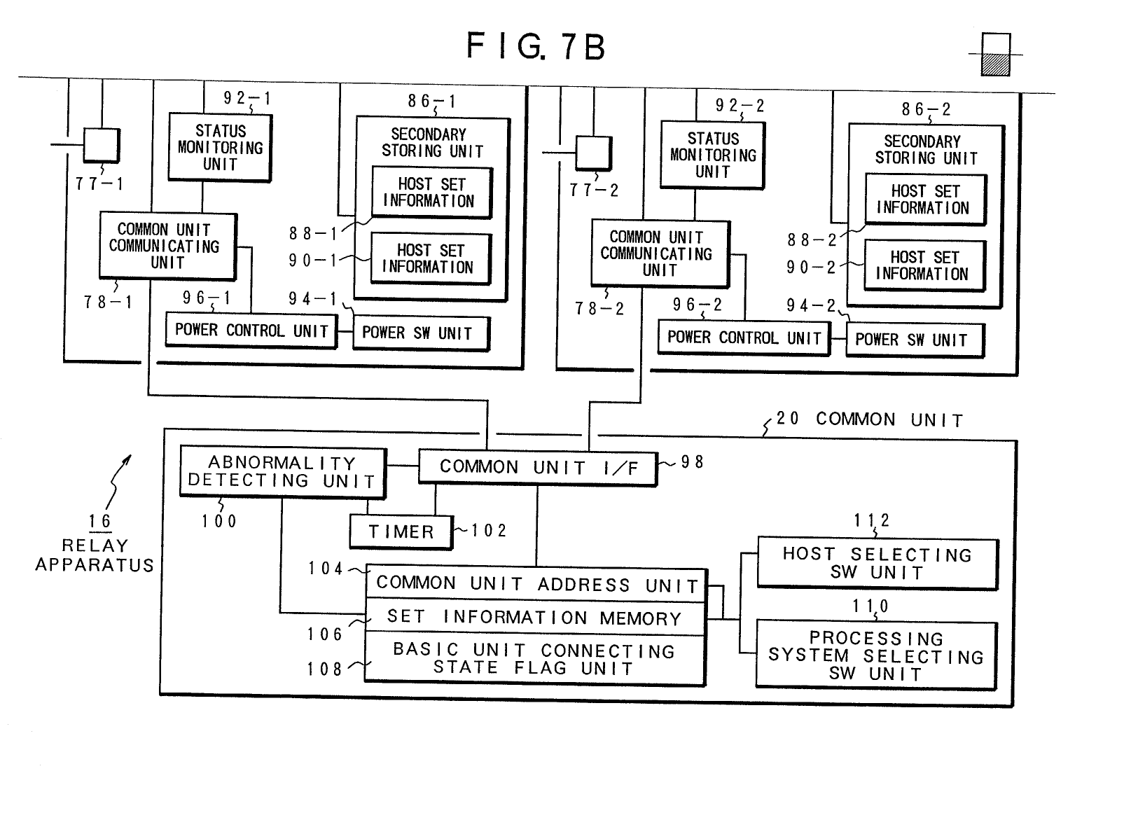

FIGS. 7A and 7B are block diagrams of a functional construction of the relay apparatus 16 of the invention corresponding to the hardware constructions of FIGS. 5, 6A, and 6B. The first basic unit 18-1 of the relay apparatus 16 comprises: a host communication control unit 74-1; a setting unit 80-1; an address memory 82-1; an address ROM 84-1; a secondary storing unit 86-1 using an HDD; a power switch unit 94-1; and a power control unit 96-1. The host communication control unit 74-1 transmits and receives data to/from, for example, the host computer 10-1 of the present system through the network 12 by using the common network address stored in the address memory 82-1. As a common network address for the address memory 82-1, the address transmitted from the common unit 20 at the time of power-on of the first basic unit 18-1 is stored and used. A common network address for backup in the case where the common network address is not derived from the common unit 20 has fixedly been stored in the address ROM 84-1. To connect to the host computers 10-1 and 10-2, the host communication control unit 74-1 reads out and uses host set information 88-1 of the host computer 10-1 of the present system or host set information 90-1 of the host computer 10-2 of the standby system stored in the secondary storing unit 86-1. The host set information 88-1 and 90-1 stored in the secondary storing unit 86-1 are stored by the input operation from the setting unit 80-1.

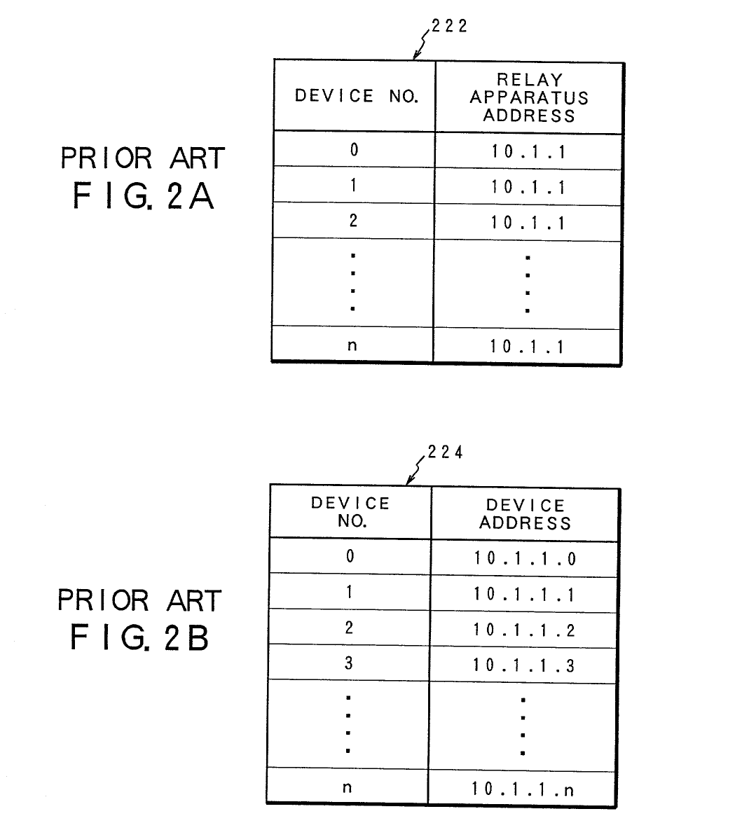

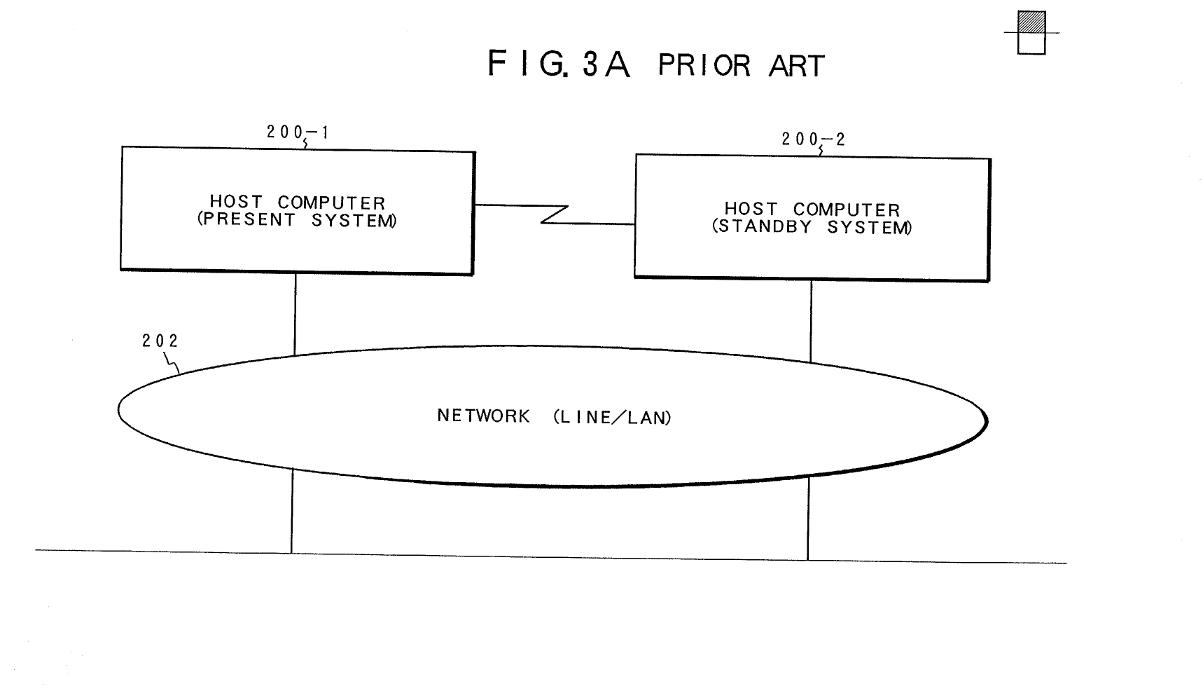

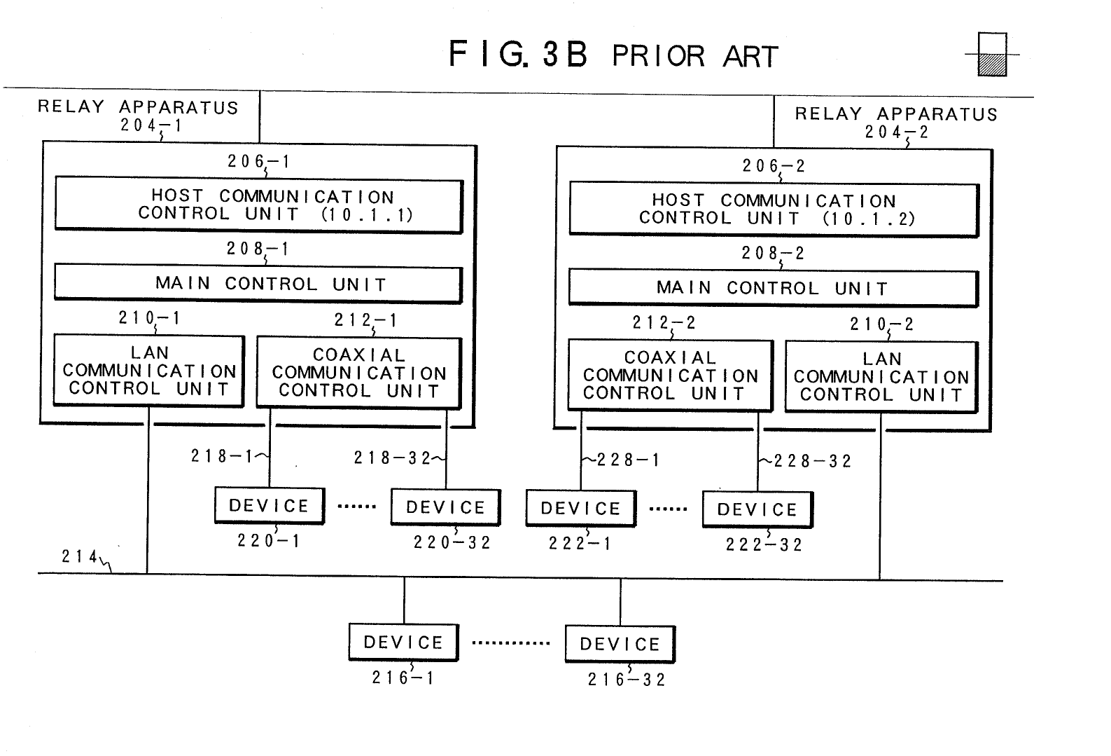

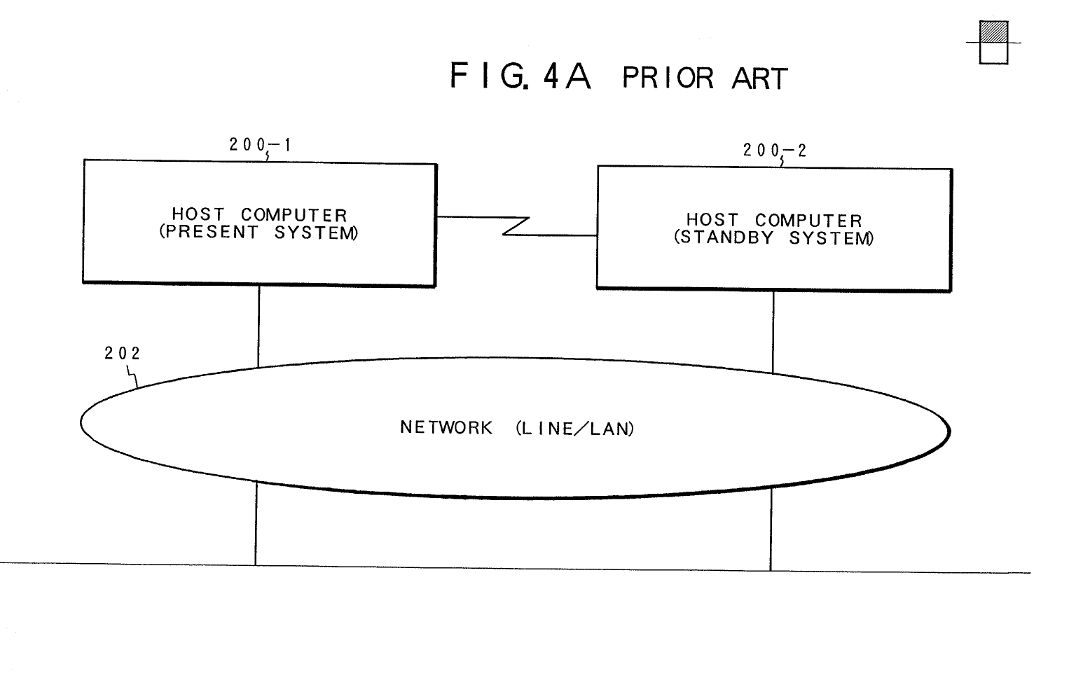

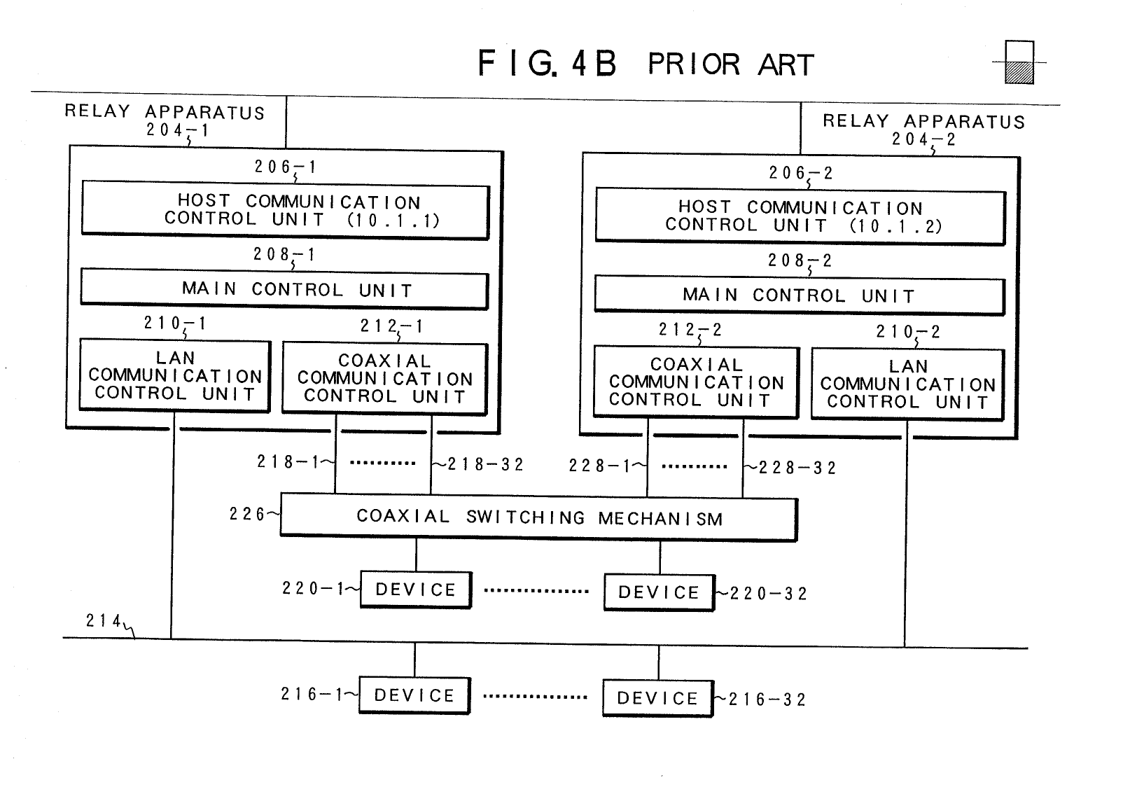

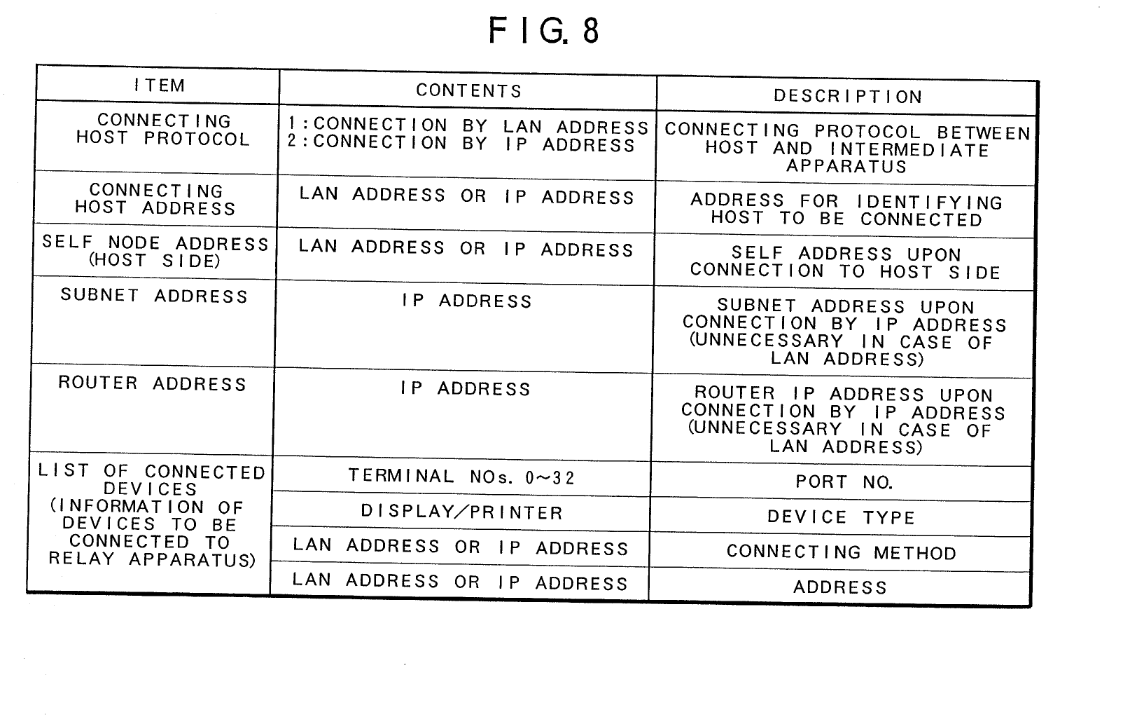

FIG. 8 shows an example of the host set information 88-1 and 90-1 stored in the secondary storing unit 86-1 of the first basic unit 18-1 in FIGS. 7A and 7B. The host set information comprises the following set items, that is: a connecting host protocol; a connecting host address; a self node address (host side); a subnet address; a router address; and a list of connected devices (device corresponding table). When explaining further in detail, the connecting host protocol defines a connecting protocol between the host computer and the relay apparatus. When “2” is set, the connecting protocol by the LAN address is set. When “2” is set, the connecting protocol by the IP address is set. The next connecting host address is an address for identifying the host computer which is connected and the LAN address or IP address is set. The self node address (host side) is a self address at the time of connecting to the host computer and corresponds to the common network address in the relay apparatus of the invention. In the relay apparatus of the invention, as for the common network address, the common network address which has been stored in the address memory 82-1 and received from the common unit 20 as shown in FIGS. 4A and 4B is used irrespective of the host set information. The next subnet address is a subnet address at the time of connecting by the IP address and naturally becomes unnecessary in case of the LAN address. In the relay apparatus 16 of the invention, since the single common network address is used for the network 12, the subnet address is not particularly necessary. The next router address is a router IP address at the time of connecting by the IP address and naturally becomes unnecessary in case of the LAN address. Further, the last list of the connected devices is corresponding table information for specifying the addresses of the devices connected to the relay apparatus by terminal numbers (device numbers). For example, 0 to 32 are set as terminal numbers and, for example, the display or printer can be set as a device type. Further, either the LAN address or the IP address corresponding to the head connecting host protocol is set as a connecting method. Moreover, the LAN address or IP address is set as a device address. A relation between the terminal Nos. 0 to 32 in the connected device list and the LAN address or IP address substantially constructs the corresponding table in the relay apparatus shown in FIG. 2B.

Referring again to FIGS. 7A and 7B, a main control unit 76-1 executes a relay control between the host computer and the device. That is, the main control unit 76-1 receives a request from the device side, transmits it to the host computer 10-1, receives response data from the host computer 10-1 in response to such a request, and transmits the received data to the corresponding device. For the purpose of performing the relay control of the host computer in the main control unit 76-1 and the device side, the terminal number of the device in the connected device list shown in FIG. 8 included in the host set information 88-1 of the host computer 10-1 of the present system stored in the secondary storing unit 86-1 and the corresponding address of such a terminal number are used. That is, the device address is obtained from the terminal number included in the data received from the host computer 10-1 and the received data is transmitted to the obtained device address. Besides the host set information 88-1 and 90-1 of the host computer 10-1 of the present system and the host computer 10-2 of the standby system, a character signal such as font or the like and data such as overlay data which are used when a program that was downloaded from the host computer side or data transmitted from the host computer side is outputted to the printer or display are stored into the secondary storing unit 86-1 of the first basic unit 18-1. By using a common unit communicating unit 78-1, a status monitoring unit 92-1 periodically notifies the common unit 20 of a state code obtained as a result of a self diagnosis which is executed during the operation of the basic unit 18-1. That is, the basic unit 18-1 performs the relay control of the host computer 10-1 and the device side by the main control unit 76-1 and, at the same time, executes in parallel a storing process and an outputting process of the resources downloaded from the host computer side into/from the secondary storing unit 86-1 and, further, a protocol converting process for the network 12. Therefore, the writing and reading operations to/from the secondary storing unit 86-1 are frequently executed, the processes are complicated, and a load is also large, so that a fault ratio is relatively high. Therefore, the status monitoring unit 92-1 periodically notifies the common unit 20 of the status of the main control unit 76-1 serving as a center of the relay control, thereby allowing the switching and shift to the second basic unit 18-2 to be promptly performed on the common unit 20 side in response to the occurrence of the abnormality in the basic unit 18-1. The power switch unit 94-1 has a switch for turning on or off the power source of the first basic unit 18-1. The power switch unit 941 is connected to the power control unit 96-1. When the power switch unit 9-41 is turned on, the power control unit 96-1 notifies the common unit 20 of the execution of the power-on operation, and thereafter, turns on the power source of the first basic unit 18-1 if a power-on instruction is received on the basis of processing system selection information set into the common unit 20 side. If the abnormality is detected during the use of the basic unit and the switching and shift to the other basic unit is performed, with respect to the abnormality occurrence side, the power source is turned off in response to a power-off instruction from the common unit 20. With respect to the switching shift destination, the power-on instruction from the common unit 20 is received and the power source is turned on. Therefore, even if the basic unit 18-1 is in the operation stop mode due to the power source means, the common unit communicating unit 78-1 and power control unit 96-1 are always in the operative mode in which the power supply is received. Such a functional construction of the first basic unit 18-1 as mentioned above is also similarly applied to the second basic unit 18-2. That is, the second basic unit 18-2 comprises: a host communication control unit 74-2; a main control unit 76-2; a common unit communicating unit 78-2; a setting unit 80-2; an address memory 82-2; an address ROM 84-2; a secondary storing unit 86-2; a power switch unit 94-2; and a power control unit 96-2. Host set information 88-2 of the host computer 10-1 of the present system and host set information 90-2 of the host computer 10-2 of the standby system which have the contents shown in FIG. 8 have been stored in the secondary storing unit 86-2 on the basis of the inputting operation of the setting unit 80-2. The common unit 20 comprises: a common unit interface 98; an abnormality detecting unit 100; a timer 102; a common unit address unit 104; a set information memory 106; a basic unit connecting state flag unit 108; a processing system selecting switch unit 110; and a host selecting switch unit 112. The common unit 20 has a function for monitoring the abnormality of the first basic unit 18-1 or second basic unit 18-2 in the operative mode and a function for the shift control upon occurrence of the abnormality. For this purpose, through the common unit I/F 98, the abnormality detecting unit 100 receives the state code which is periodically transmitted from, for example, the status monitoring unit 92-1 of the first basic unit 18-1 in the operative mode, thereby detecting the presence or absence of the abnormality from the received state code. When the abnormality of the first basic unit 18-1 is detected from the state code, the shift control from the first basic unit 18-1 in which the abnormality occurred to the second basic unit 18-2 in the standby mode is performed by the common unit VF 98. The shift control is executed by the following procedure.

(I) Power-off of the basic unit in which the abnormality occurred

(II) Power-on of the basic unit on the shift destination side

(III) Transmission of the common network address to the basic unit on the shift destination side

The timer 102 is provided for the abnormality detecting unit 100. Each time the state code is received from, for example, the first basic unit 18-1 in the operative mode, the abnormality detecting unit 100 sets a predetermined interruption set time into the timer 102 and reactivates it. Therefore, if the abnormality occurs in the first basic unit 18-1 and the state code cannot be periodically received from the status monitoring unit 92-1, time-out of the timer 102 occurs.

Also in this case, the abnormality detecting unit 100 detects the occurrence of the abnormality of the first basic unit 18-1 and performs the shift control to the second basic unit 18-2 in the standby mode. The common network address which is used in the host communication control unit 74-1 or 74-2 of the first basic unit 18-1 or the second basic unit 18-2 has been stored in the common unit address unit 104 of the common unit 20. The common network address stored in the common unit address unit 104 is read out and transmitted to the basic unit whose power source has been turned on and set into the address memory 82-1 or 82-2, thereby enabling it to be used in the host communication control unit 74-1 or 74-2 for the purpose of communicating with the host computer. Thus, even if the relay control function is shifted from the first basic unit 18-1 to the second basic unit 18-2, the common network address can be certainly taken over. On the contrary, even if the relay control function is shifted from the second basic unit 18-2 to the first basic unit 18-1, the common network address can be also similarly taken over. Selection information set by the processing system selecting switch unit 110 and host selecting switch unit 112 has been stored in the set information memory 106 of the common unit 20. The selection information is used for selecting the basic unit on the present side to be set into the operative mode when the relay apparatus is activated by performing the power-on operation by the power switch unit 94-1 or 94-2 of the first basic unit 18-1 or second basic unit 18-2. That is, if the basic unit which is activated as a present system is previously selected by the processing system selecting switch unit 1 10 and stored into the set information memory 106, even when either the power switch unit 94-1 of the first basic unit 18-1 or the power switch unit 94-2 of the second basic unit 18-2 is turned on, the common unit interface 98 of the common unit 20 is notified of the power-on operation. Thus, the common unit interface 98 obtains the selection information of the processing system at that time with reference to the set information memory 106 and instructs the power-on to the selected basic unit side. The host selecting switch unit 112 can instruct the selection of the host computer 10-1 or 10-2 to which the basic unit activated by the power-on is connected. That is, if the power-on operation is executed by either the power switch unit 94-1 of the first basic unit 18-1 or the power switch unit 94-2 of the second basic unit 18-2, the common unit interface 98 of the common unit 20 is notified of the power-on operation. The host selection information stored in the set information memory 106 is read out and a setting instruction of the selected host is issued to the basic unit side together with the power-on instruction to the processing system. Therefore, for example, the first basic unit 18-1 activated by the power-on instruction from the common unit 20 simultaneously reads out the host set information 88-1 or 90-1 for the selected host computer instructed by the common unit 20 from the secondary storing unit 86-1 and sets it into the host communication control unit 74-1, thereby enabling the relay apparatus 16 to be connected to one of the host computers 10-1 and 10-2 selected by the host selecting switch unit 112 of the common unit 20. Further, information showing whether the first basic unit 18-1 and second basic unit 18-2 have been connected to the common unit 20 or not has been stored as flag information into the basic unit connecting state flag unit 108 of the common unit 20. For example, in a case where the second basic unit 18-2 is not provided for the relay apparatus and only the first basic unit 18-1 is connected, even if the occurrence of the abnormality of the first basic unit 18-1 is detected by the abnormality detecting unit 100, the shift control to the second basic unit 18-2 which is not connected is not performed.

Subsequently, the processing operation of the relay apparatus 16 of the invention in the embodiment of FIGS. 7A and 7B will be explained separately with respect to the following three operations.

(I) Switching shift due to the automatic detection of abnormality

(II) Switching shift by the manual operation

(III) Switching of the host

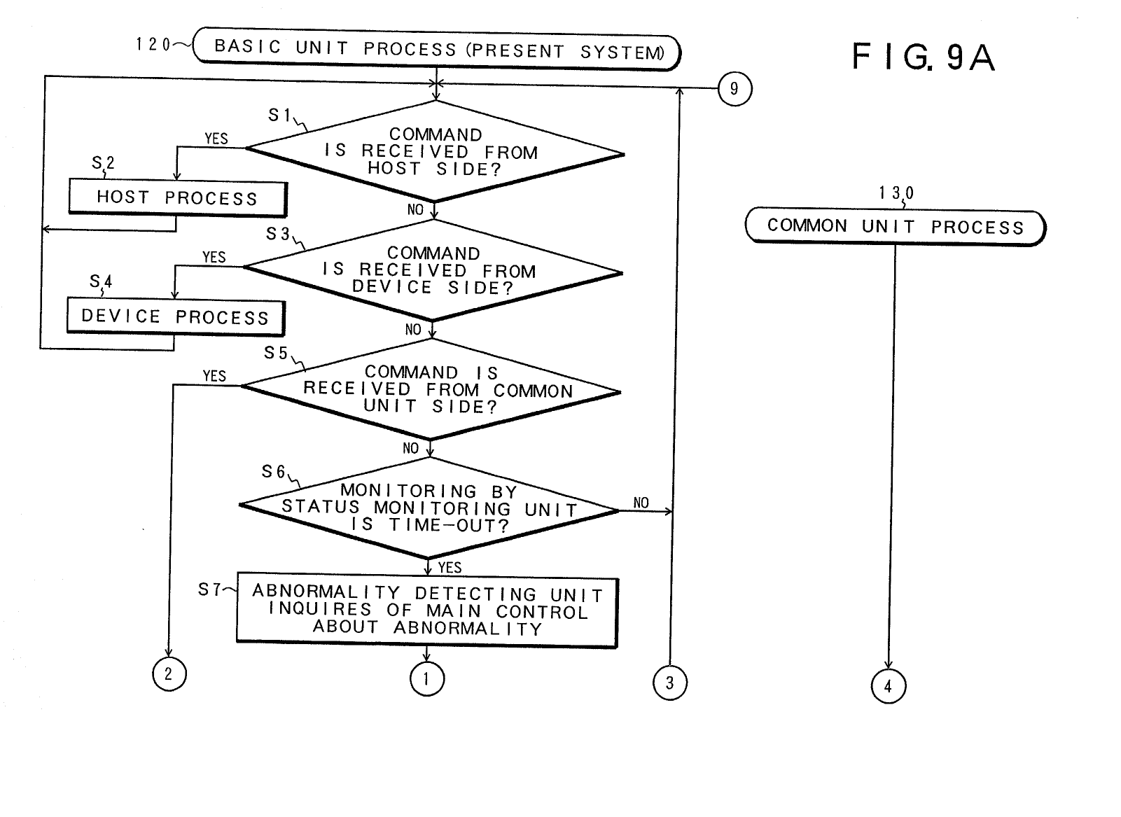

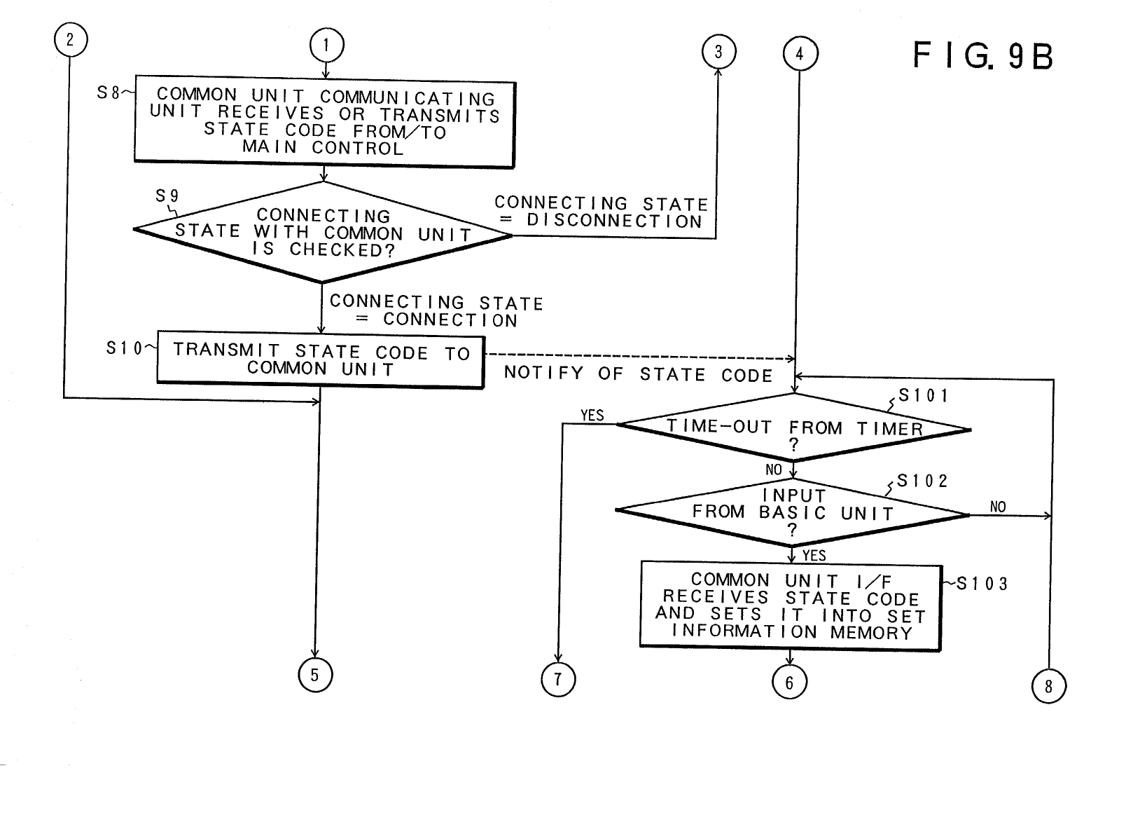

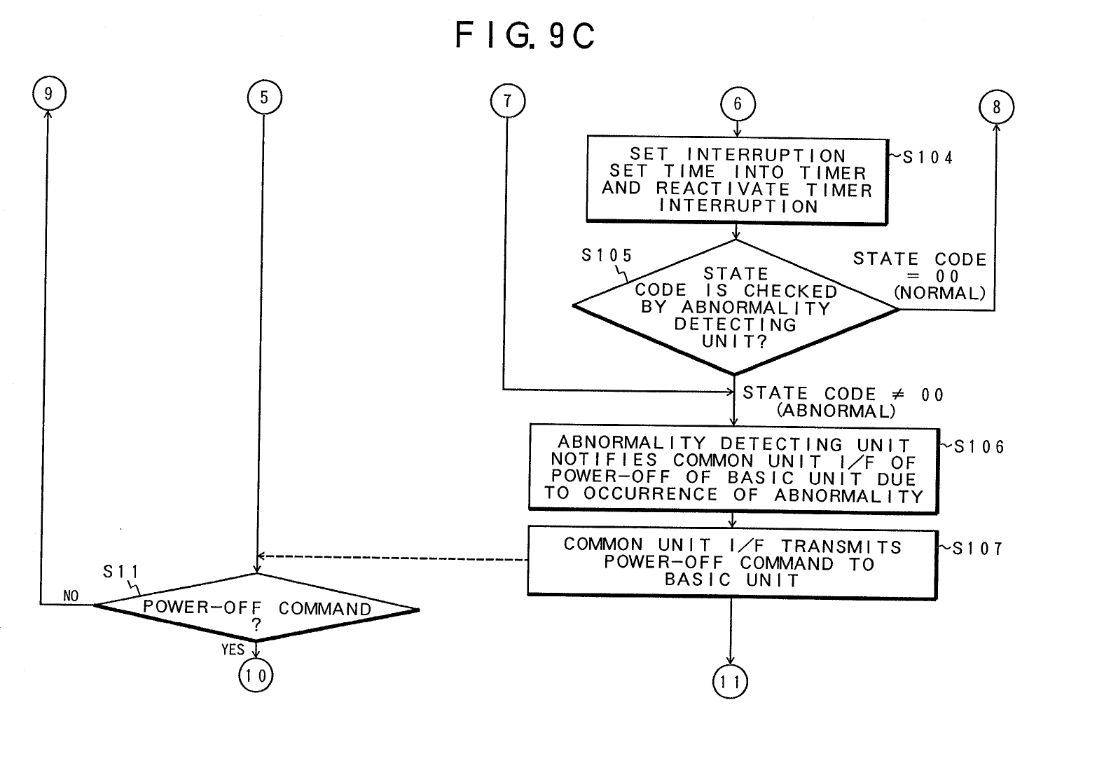

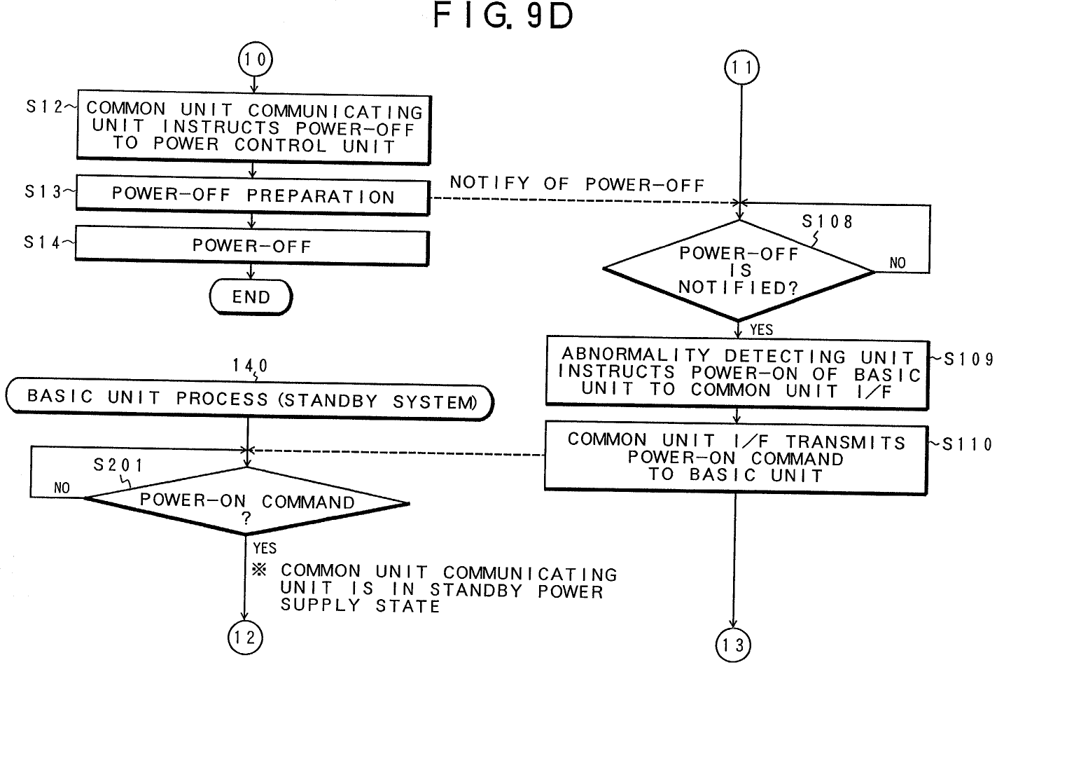

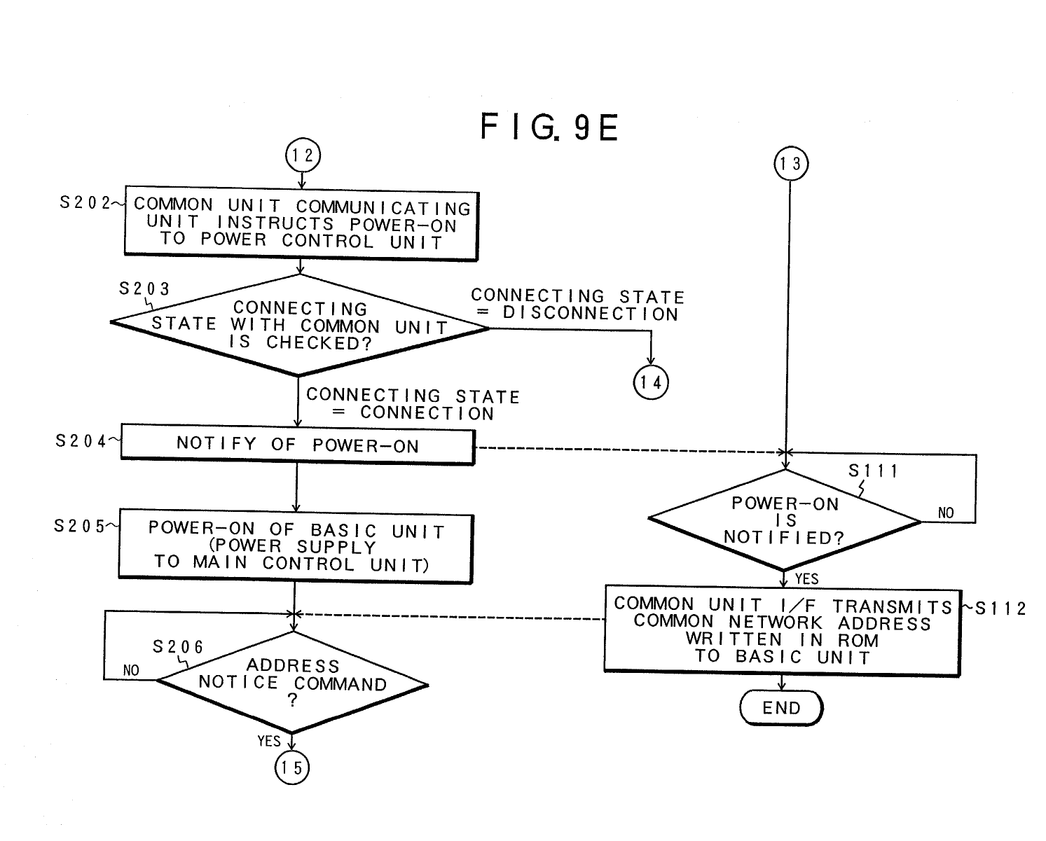

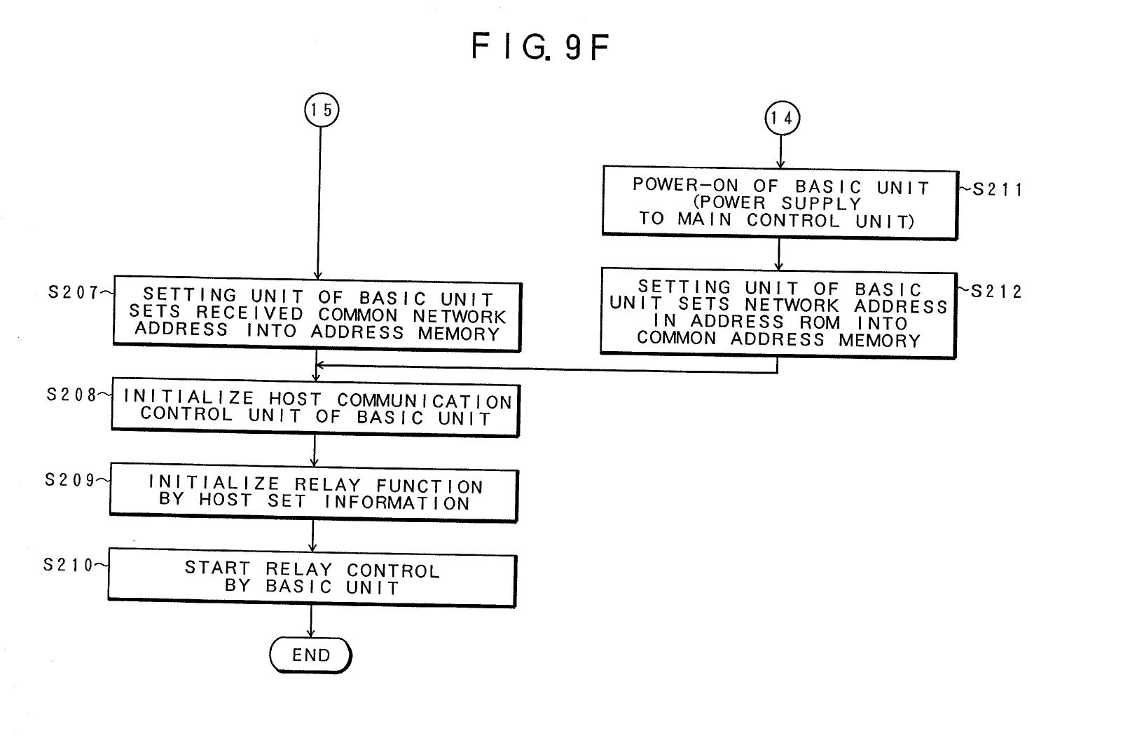

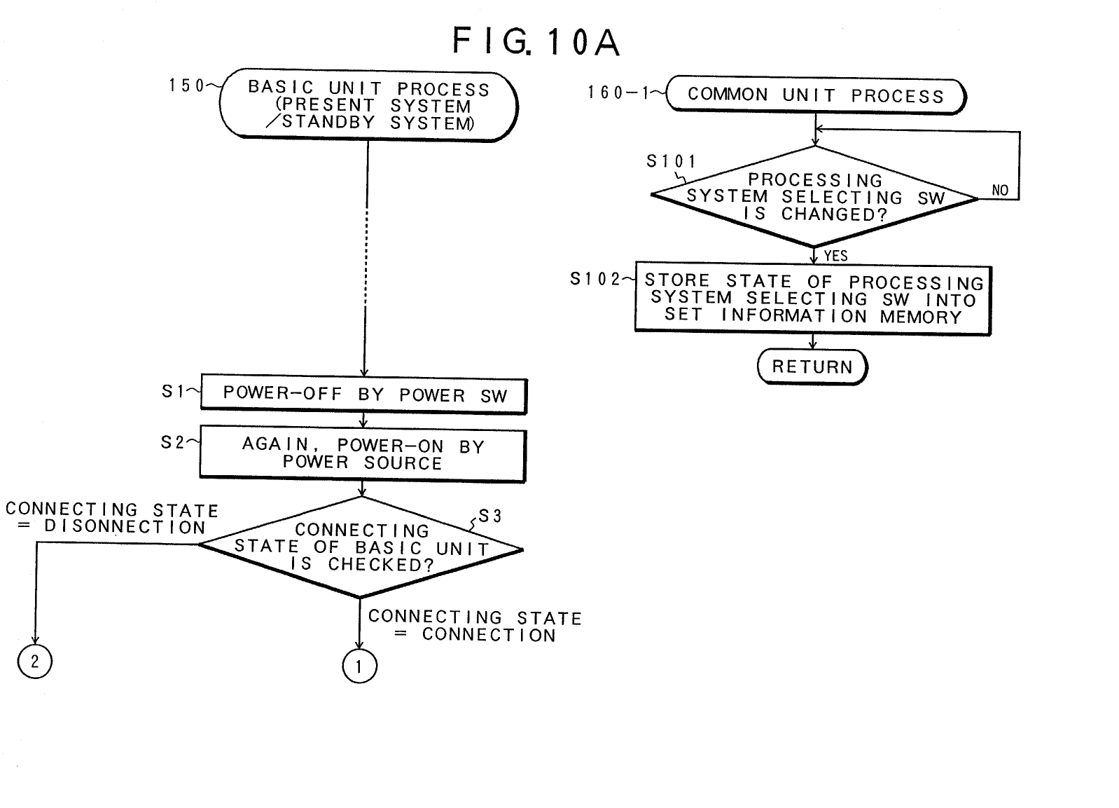

FIGS. 9A to 9F are flowcharts for the switching shift due to the automatic abnormality detection in the case where in a state where the first basic unit 18-1 operates as a present system and the second basic unit 18-2 is stopped as a standby system in the relay apparatus 16 in FIGS. 7A and 7B, the abnormality of the first basic unit 18-1 is detected and the process is automatically switched to the second basic unit 18-2 of the standby system. On the host computer side, a case where the host computer 10-1 operates as a present system and the host computer 10-2 is stopped as a standby system is presumed as an example.

A basic unit process 120 in FIG. 9A is a process of the first basic unit 18-1 of the relay apparatus 16 which operates as a present system at present. In the basic unit process 120, whether a command from the host computer 10-1 has been received or not is discriminated in step S1. When the command is received, step S2 follows and a necessary host process based on the command received from the host is executed. Subsequently, in step S5, whether a command from the common unit 20 has been received or not is discriminated. Since it is not received generally, step S6 follows. In step S6, a time-out of a monitoring timer provided for the status monitoring unit 92-1 has occurred or not is discriminated. If the time-out of the monitoring timer occurred, step S7 follows. The status monitoring unit 92-1 inquires the main control unit 76-1 about the abnormality. The state code obtained by the inquiry to the main control unit 76-1 is notified from the status monitoring unit 92-1 to the common unit communicating unit 78-1 in step S8. The common unit communicating unit 78-1 transmits the obtained state code to the common unit 20. Subsequently, in step S9, the connecting state of the basic unit to the common unit 20 is discriminated. If it indicates disconnection, the processing routine is returned to step S1. If it is connected, step S10 follows and the state code is transmitted to the common unit 20. As for the state code transmitted to the common unit 20, a time-out of the timer 102 is discriminated by a process in step S101 of a common unit process 130 in FIG. 9B and, thereafter, the state code received from the basic unit 18-1 is inputted in step S102. In step S103, the common unit I/F 98 sets the received state code into the set information memory 106. Subsequently, in step S104, a predetermined interruption set time is set into the timer 102 and it is reactivated. In step S105, the state code received from the basic unit 18-1 is read out from the set information memory 106 and checked by the abnormality detecting unit 100. Since the state code is equal to “00” when the basic unit is normal, the processing routine is returned to step S101 and the processes up to step S105 are repeated. When the abnormality occurs in the basic unit 18-1, the received state code is equal to a value other than “00” indicative of the normal state. The processing routine advances to step S106 in FIG. 9C. If the abnormality such that the state code is not received from the first basic unit 18-1 occurs after the reactivation of the timer 102, the time-out of the timer 102 is discriminated in step S101 and step S106 in FIG. 9C follows. The abnormality detecting unit 100 of the common unit 20 instructs a power-off notice to the common unit I/F 98 on the basis of the abnormality detection according to the state code. Thus, the common unit I/F 98 transmits the power-off instruction to the first basic unit 18-1 in step S107.

In the basic unit process 120 of the first basic unit 18-1 which received a command transmitted from the common unit 20, when it is determined in step S5 in FIG. 9A that the command from the common unit 20 side has received, step S11 in FIG. 9C follows and whether the received command is the power-off command or not is discriminated. If it is the power-off command, step S12 follows. The common unit communicating unit 78-1 instructs the power-off to the power control unit 96-1. In response to it, the power control unit 96-1 prepares for the power-off in step S13 and turns off the power source in step S14, so that the first basic unit 18-1 which is operating as a present system is stopped on the basis of the abnormality occurrence. In the power-off preparation in step S13, the power-off notice is transmitted from the common unit communicating unit 78-1 to the common unit 20. When the common unit 20 receives the power-off notice from the first basic unit 18-1 in step S108, in step S109, the abnormality detecting unit 100 instructs the power-on of the second basic unit 18-2 of the standby system at present to the common unit I/F 98. In response to it, the common unit I/F transmits the power-on command to the second basic unit 18-2 in step S110.

In a basic unit process 140 of the second basic unit 18-2, whether the power-on command from the common unit 20 has been received or not is discriminated in step S201 in FIG. 9D. The common unit communicating unit 78-2 and power control unit 96-2 of the second basic unit 18-2 are in a standby power supply state and can execute the operation corresponding to the reception of the power-on command from the common unit 20. If it is determined in step S201 that the power-on command from the common unit 20 has been received, in step S202, the common unit communicating unit 78-2 of the second basic unit 18-2 instructs the power control unit 96-2 to turn on the power source. Subsequently, in step S203, the common unit communicating unit 78-2 discriminates a connecting state of the basic unit to the common unit 20. If it is connected, step S204 follows and the power-on notice is transmitted. After that, in step S205, the power source of the second basic unit 18-2 is turned on, so that the power source is supplied to the main control unit 76-2 and it starts the operation. The power-on notice transmitted in step S204 is received by the common unit 20 and discriminated in step S111. In step S112, the common unit I/F 98 reads out the common network address written in an ROM constructing the common unit address unit 104 and transmits it to the second basic unit 18-2 on the shift destination side, thereby allowing the common network address before the shift to be taken over to the shift destination side. The common network address transmitted in step S112 is received by the common unit communicating unit 78-2 of the second basic unit 18-2 in step S206. When it is determined that it indicates a notice command of the common network address, the processing routine advances to step S207 in FIG. 9F. The setting unit 80-2 of the second basic unit 18-2 sets the common network address received from the common unit 20 into the address memory 82-2.

If it is determined in step S203 in FIG. 9E that the connecting state of the second basic unit 18-2 to the common unit 20 is disconnection, step S211 in FIG. 9F follows. The power source of the second basic unit 18-2 is turned on solely by the power control unit 96-2 without notifying the common unit 20 of the power-on, thereby supplying the power source to the main control unit 76-2 and starting the operation. Subsequently, in step S212, since the common network address is not received from the common unit 20, the setting unit 80-2 of the second basic unit 18-2 reads out the common network address stored in the address ROM 842 and sets it into the address memory 82-2. After the common network address was set into the address memory 82-2 in step S207 or S212, in step S208, the host communication control unit 74-2 of the second basic unit 18-2 is initialized by using the common network address set into the address memory 82-2. Further, in step S209, the host set information 88-2 regarding the host computer 10-1 of the present system stored in the secondary storing unit 86-2 is read out and the relay function in the main control unit 76-2 is initialized. In step S210, the relay control between the host computer 10-1 of the present system which validated the relay function of the second basic unit 18-2 and the device is started.

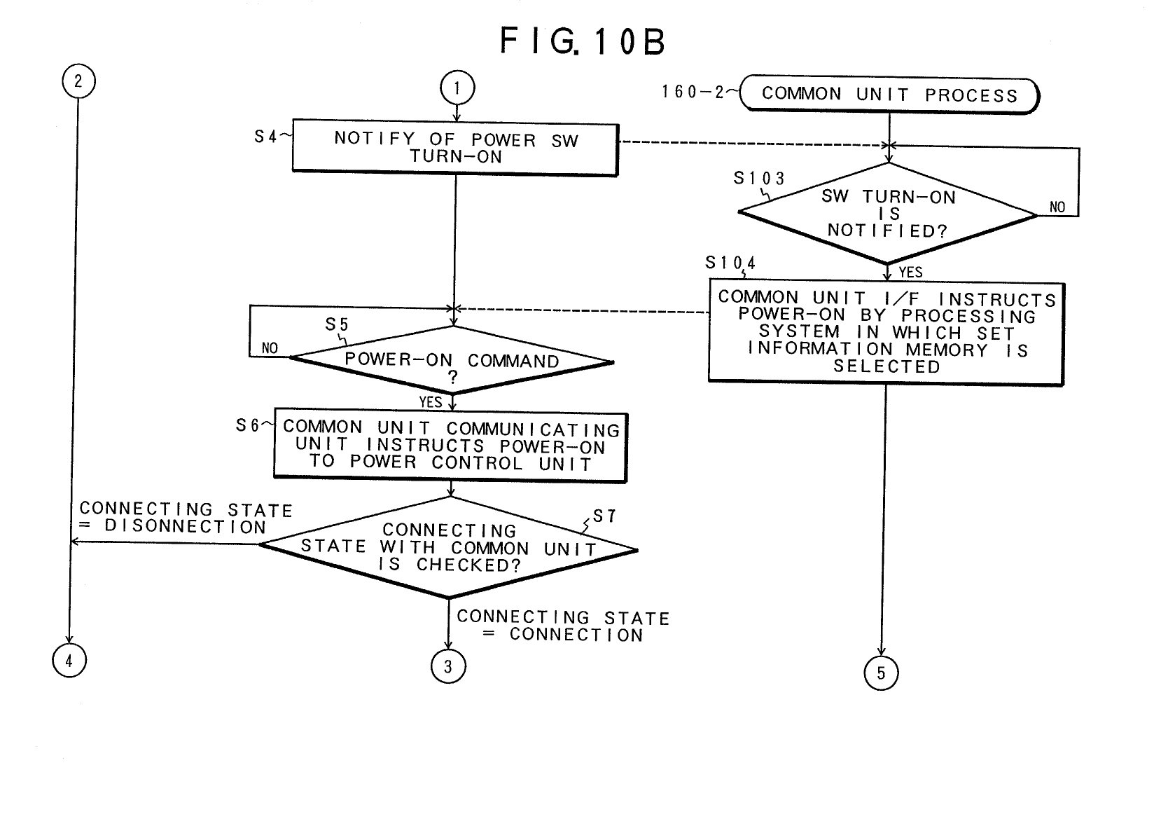

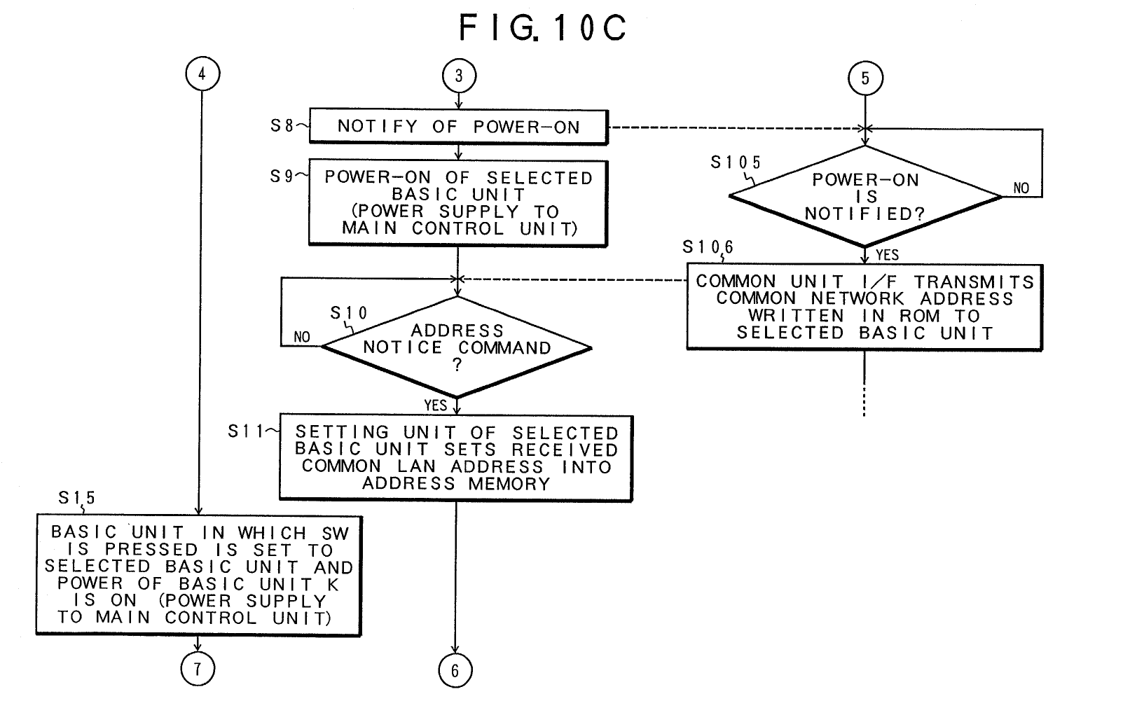

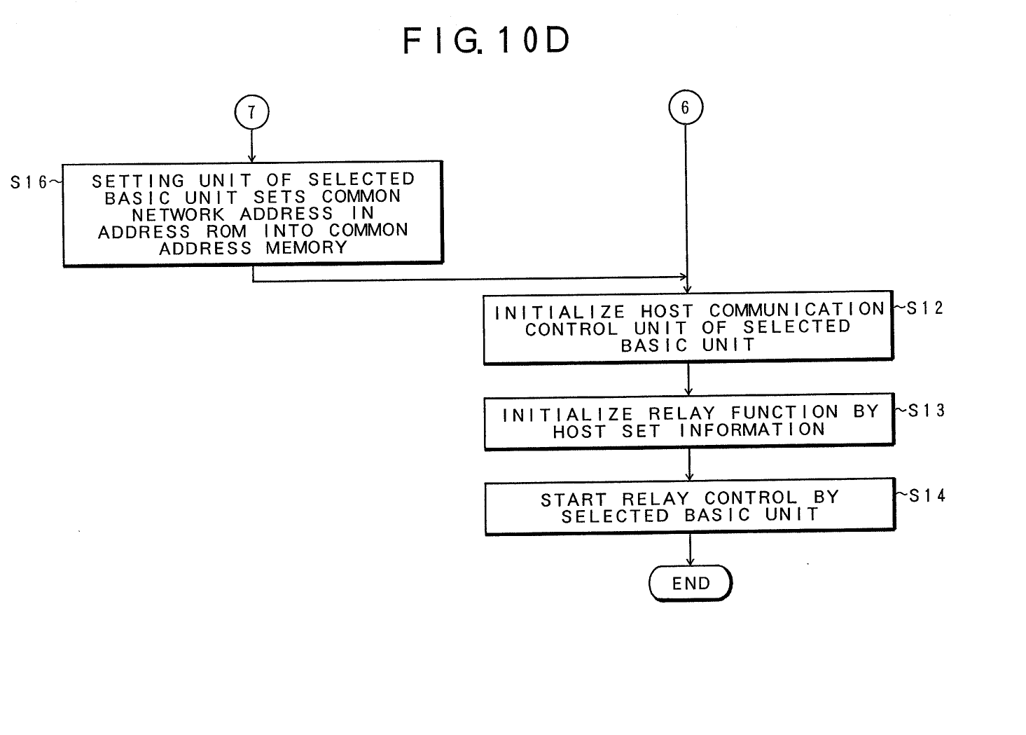

FIGS. 10A to 10D are flowcharts for the switching shift of the basic unit according to the manual operation in the relay apparatus 16 of the invention. It is now presumed a case, as an example, where in FIGS. 7A and 7B, the first basic unit 18-1 side is operating as a present system and, in this state, it is switched and shifted to the second basic unit 18-2 of the standby system by the manual operation. Prior to the switching shift by the manual operation, first, in a common unit process 160-1 in FIG. 10A, the operator or maintenance person operates the processing system selecting switch unit 110 of the common unit 20 and selects the second basic unit 18-2 as a shift destination side. In association with the operation of the processing system selecting switch unit 110, in the common unit process 160-1, the presence or absence of a change of the processing system selecting switch unit 110 is discriminated in step S101. If there is the change, step S102 follows and a status of the processing system selecting switch unit 110 is stored into the set information memory 106. After completion of the selecting operation of the processing system in the common unit 20 as mentioned above, by performing the power-off operation of the power switch unit 94-1 of the first basic unit 18-1 which is operating as a present system, the shift switching to the automatically selected second basic unit 18-2 is subsequently performed. In a basic unit process 150 regarding the first basic unit 18-1 serving as a present system, first, in step S1, the power-off operation of the power switch unit 94-1 is executed. After that, the power-on operation is again performed in step S2. When the power-off operation and the operation to again turn on the power supply are executed, the common unit communicating unit 78-1 discriminates the connecting state to the common unit 20. If it indicates connection, the common unit 20 is notified of the power-on operation in step S4. In a common unit process 160-2 by the common unit 20 which received the notice of the power-on operation from the first basic unit 18-1, when there is the notice of the power-on operation in step S103, the common unit I/F 98 instructs the power-on in the selection processing system stored in the set information memory 106 at this time in step S104. In this case, since the processing system selection of the second basic unit 18-2 has been stored by the processing system selecting switch unit 110 by the processes in steps S101 and S102 of the common unit process 160-1, the power-on is instructed to the selected second basic unit 18-2. Processes in step S5 and subsequent steps in the basic unit process 150 are processes of the standby system serving as a shift destination side. Therefore, the power-on instruction in step S104 of the common unit 20 is recognized by the discriminating process of the power-on command in step S5 in the basic unit process 150. The processing routine advances to step S6. The common unit communicating unit 78-2 of the second basic unit 18-2 instructs the power control unit 96-2 to turn on the power source. Step S7 in FIG. 10B follows. In step S7, the common unit communicating unit 78-2 discriminates the connecting state to the common unit 20. If it indicates connection, the common unit 20 is notified of the power-on in step S8. After that, the power source of the selected second basic unit 18-2 is turned on in step S9, the power source is supplied to the main control unit 76-2, and the relay control is activated. The power-on notice transmitted to the common unit 20 from the second basic unit 18-2 in step S8 is recognized in step S 105 of the common unit 20. In step S106, the common network address written in the ROM constructing the common unit address unit 104 is read out and transmitted to the selected second basic unit 18-2.

As for the common network address from the common unit 20, the address notice command is discriminated in step S10 in the process of the second basic unit 18-2. In step S11, the setting unit 80-2 of the selected second basic unit 18-2 sets the received common network address into the address memory 82-2. In step S12, the host communication control unit 74-2 of the selected second basic unit 18-2 is initialized by using the common network address set in the address memory 82-2. In step S13, the host set information 88-2 regarding the host computer 10-1 of the present system stored in the secondary storing unit 86-2 is read out and the main control unit 76-2 is initialized, thereby activating the relay control. In step S14, the relay control by the selected second basic unit 18-2 is started. In the discrimination of the connecting state of the first basic unit 18-1 on the shifting source side to the common unit 20 in step S3 in FIG. 10A, if it indicates disconnection, or if the connecting state to the common unit 20 also similarly indicates disconnection in step S7 in FIG. 10B, the shift to the selected processing system by the common unit 20 is impossible. Therefore, in step S15, the side where the power switch unit has been operated is set to the selected basic unit and the power source is turned on by its power control unit. That is, since the shifting source side is the first basic unit 18-1, in this case, the power source is turned on by the self power control unit 96-1 by turning on the power supply again, the power source is supplied to the main control unit 76-1, and the relay control is activated. Further, in step S 16, since the common network address cannot be received from the common unit 20 side, the setting unit 80-1 reads out the common network address from the address ROM 84-1 and sets it into the address memory 82-1. After the host communication control unit was initialized by the common network address in step S12 and the relay function was initialized by using the host set information 88-1 of the main control unit in step S13, the relay control of the first basic unit 18-1 which was reactivated is started in step S14. As mentioned above, in the relay apparatus 16 of the invention, by preliminarily selecting the basic unit as a processing system to which the basic unit is shifted in the common unit 20, the shift control of the basic unit to the selected processing system can be automatically performed by the power-off operation and the operation to turn on the power source again in the basic unit of the present system. For example, the shift switching such that when a fault occurs in the first basic unit 18-1 during the use, the shift switching to the second basic unit 18-2 of the standby system is automatically performed, thereafter, the first basic unit 18-1 is repaired to the normal state, and the relay control is returned from the second basic unit 18-2 which is executing the backup operation to the original first basic unit 18-1 can be executed without fundamentally stopping the relay function by the manual operation. What is called an active maintenance can be realized.

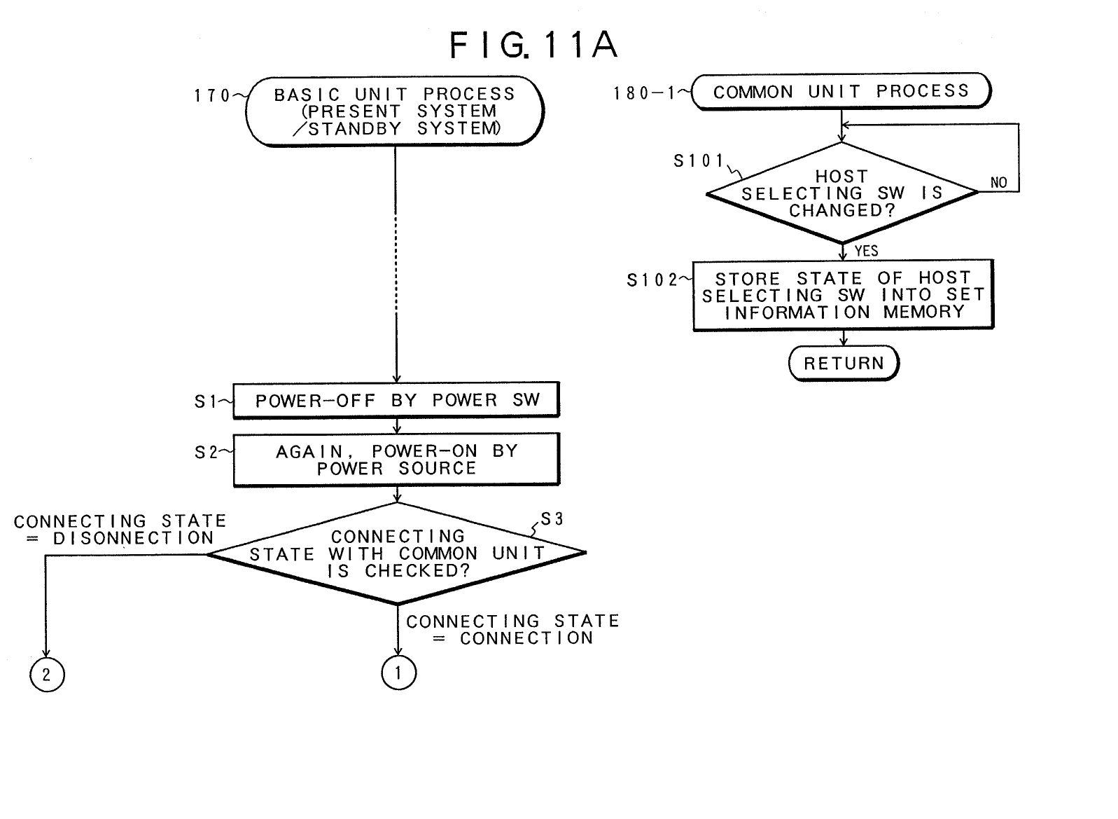

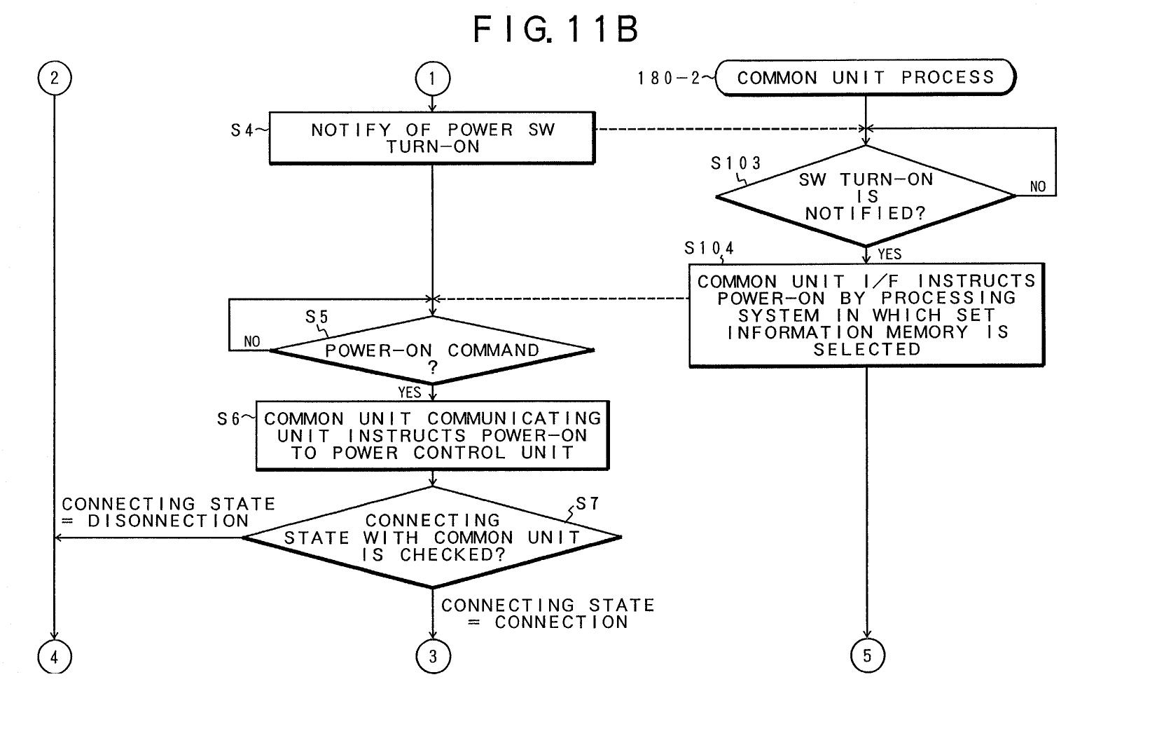

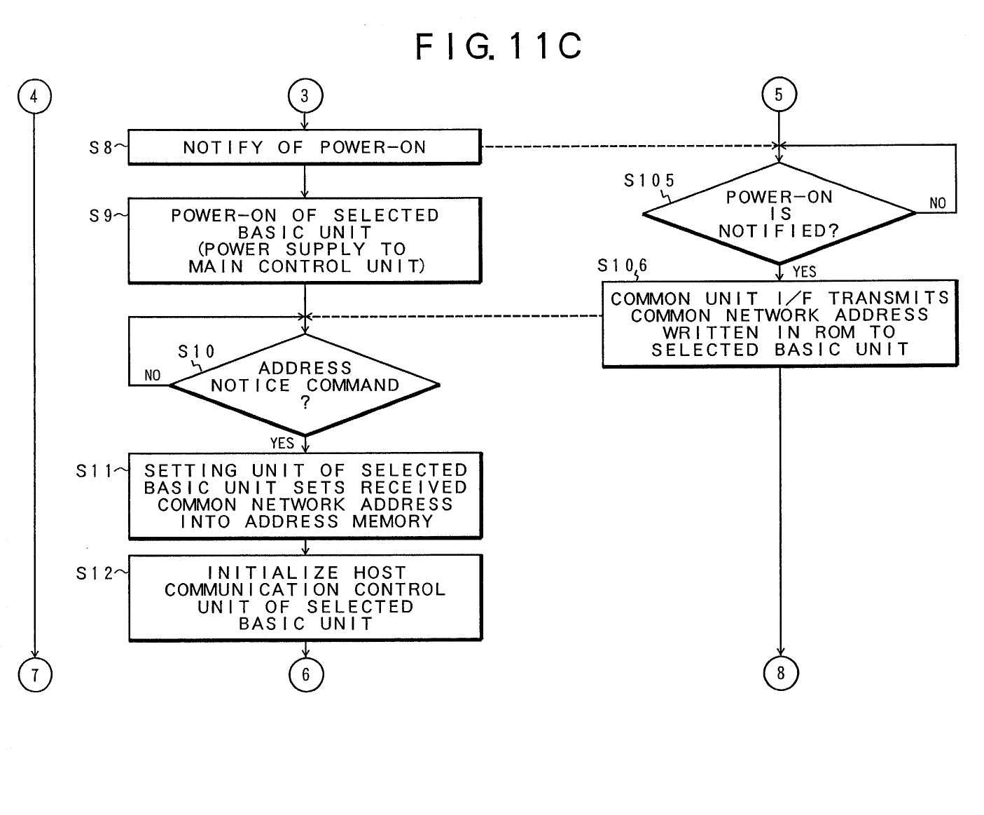

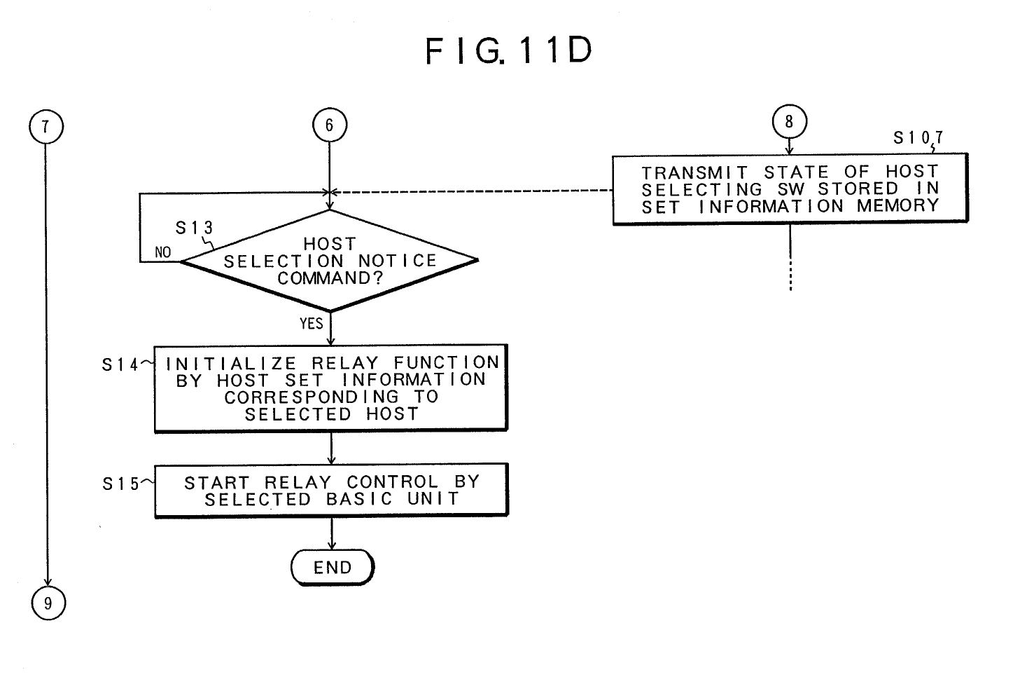

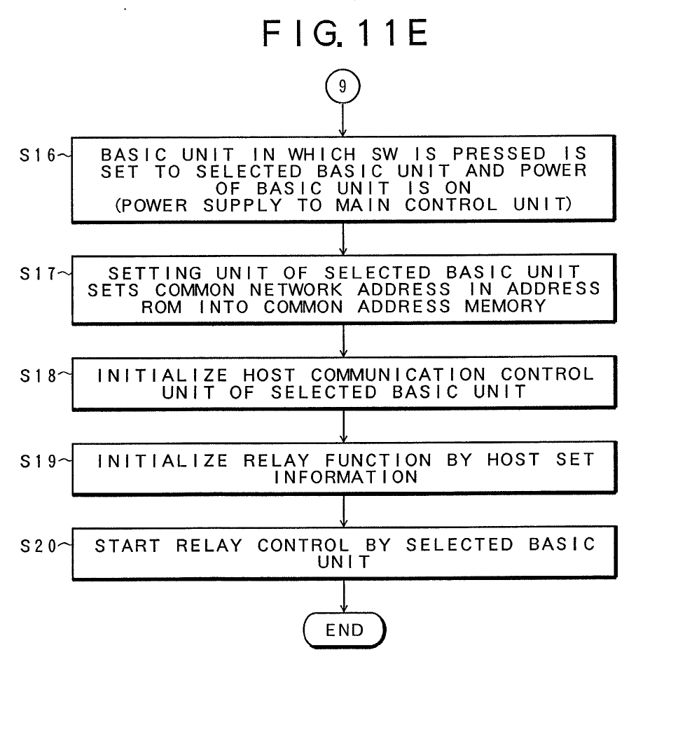

FIGS. 11A to 11E are flowcharts for a host switching process in which the host computer that is connected to the relay apparatus 16 is selected on the relay apparatus side. For example, although the host computer 10-1 is at present operating as a present system, the switching to the standby system of the host computer 10-2 is performed due to the necessity of maintenance inspection or the like, and in association with it, in the first basic unit 18-1 which is at present operating as a present system, the connection to the host computer 10-1 can be switched to the connection to the host computer 10-2 by the relay apparatus 16. Prior to the host switching, the host selecting switch unit 112 provided for the common unit 20 is operated and the selecting operation from the host computer 10-1 of the present system to the host computer 10-2 of the standby system is executed. In response to the selecting operation of the host selecting switch unit 112, in a common unit process 180-1 in FIG. 11A in the common unit 20, when the presence of a change in the host selecting switch unit 112 is recognized in step S101, step S102 follows. The state of the host selecting switch unit 112 is stored into the set information memory 106. After completion of the host selecting operation in the common unit 20 as mentioned above, the power switch unit 94-1 provided for the first basic unit 18-1 which is operating as a present system is turned off as shown in step S1 in a basic unit process 170. After that, the operation to again turn on the power supply of the power switch unit 94-1 is executed again in step S2. In association with the power-off operation and the operation to turn on the power supply again by the power switch unit 94-1 as mentioned above, the common unit communicating unit 78-1 of the first basic unit 18-1 discriminates the connecting state to the common unit 20. If it indicates the connection, the common unit 20 is notified of the power-on operation by the power switch unit 941 in step S4. In response to the notice of the power-on operation from the first basic unit 18-1, in step S103 of a common unit process 180-2, the common unit I/F 98 discriminates whether the notice of the power-on operation has been received or not. In step S104, the power-on in the processing system selected at this time and stored in the set information memory 106 is instructed. Now, assuming that the first basic unit 18-1 as a present system has been selected as a processing system, the common unit I/F 98 transmits the power-on command to the first basic unit 18-1. In the first basic unit 18-1, when it is determined in step S5 that the power-on command from the common unit 20 has been received, step S6 follows. The power-on is instructed to the power control unit 96-1. The processing routine advances to step S7 in FIG. 11B and the connecting state to the common unit 20 is discriminated. If it indicates connection, the common unit 20 is notified of the power-on in step S8. After that, in step S9, the power source of the first basic unit 18-1 as a selected basic unit is turned on, the power source is supplied to the main control unit 76-1, and the relay control is activated. The notice of the power-on notified to the common unit 20 in step S8 is discriminated by the common unit I/F 98 in step S105 in FIG. 11C. In step S106, the common unit I/F 98 reads out the common network address written in an ROM constructing the common unit address unit 104 and transmits it to the selected first basic unit 18-1. The reception of an address notice command from the common unit 20 is recognized by the common unit communicating unit 78-1 of the first basic unit 18-1 in step S10. The setting unit 80-1 of the selected first basic unit 18-1 sets the received common network address into the address memory 82-1 in step S11. In step S12, the network address to the host communication control unit 74-1 of the selected first basic unit 18-1 is initialized by using the common network address in the address memory 82-1. In next step S13, the apparatus waits for a host selection notice command from the common unit 20. At this time, in the common unit 20, the processing routine advances to step S107, the host selecting state of the host selecting switch unit 112 stored in the set information memory 106 is read out and transmitted to the basic unit 18-1. Therefore, the first basic unit 18-1 discriminates the reception of the host selection notice command from the common unit 20 in step S13. In step S14, the host set information 90-1 stored in the secondary storing unit 86-1 for the selected host, specifically speaking, the host computer 10-2 of the standby system is read out and the relay function of the main control unit 76-1 is initialized. In step S15, the first basic unit 18-1 starts the relay control between the selected host computer 10-2 of the standby system and the device. If the connecting state of the first basic unit 18-1 to the common unit 20 indicates disconnection in step S3 in FIG. 11A or in step S7 in FIG. 11B, the processing routine advances to step S16 in FIG. 11E. In this case, since the selection information of the processing system and the host selection information which are necessary for the shift of the basic unit from the common unit 20 are not obtained, the side which operated the power switch unit 94-1 is set to the selected basic unit and the power source is turned on. In step S17, the setting unit 80-1 of the basic unit 18-1 which was regarded likewise as a selected unit reads out the common network address from the address ROM 84-1 and sets it into the address memory 82-1. In step S18, the host communication control unit 74-1 is initialized by using the common network address in the address memory. The relay function in the main control unit 76-1 is initialized by using the host set information 88-1 of the host computer 10-1 of the present system in step S19. After that, the relay control is started as it is without switching the host computer 10-1 of the present system in step S20. By the switching of the host using the host selecting switch unit 112 of the common unit 20 of the relay apparatus 16 as mentioned above, in the relay apparatus 16, if a plurality of host computers can be connected, the host computer as a relay target can be arbitrarily switched as necessary without being aware of a distinction on the use such as present system and standby system.

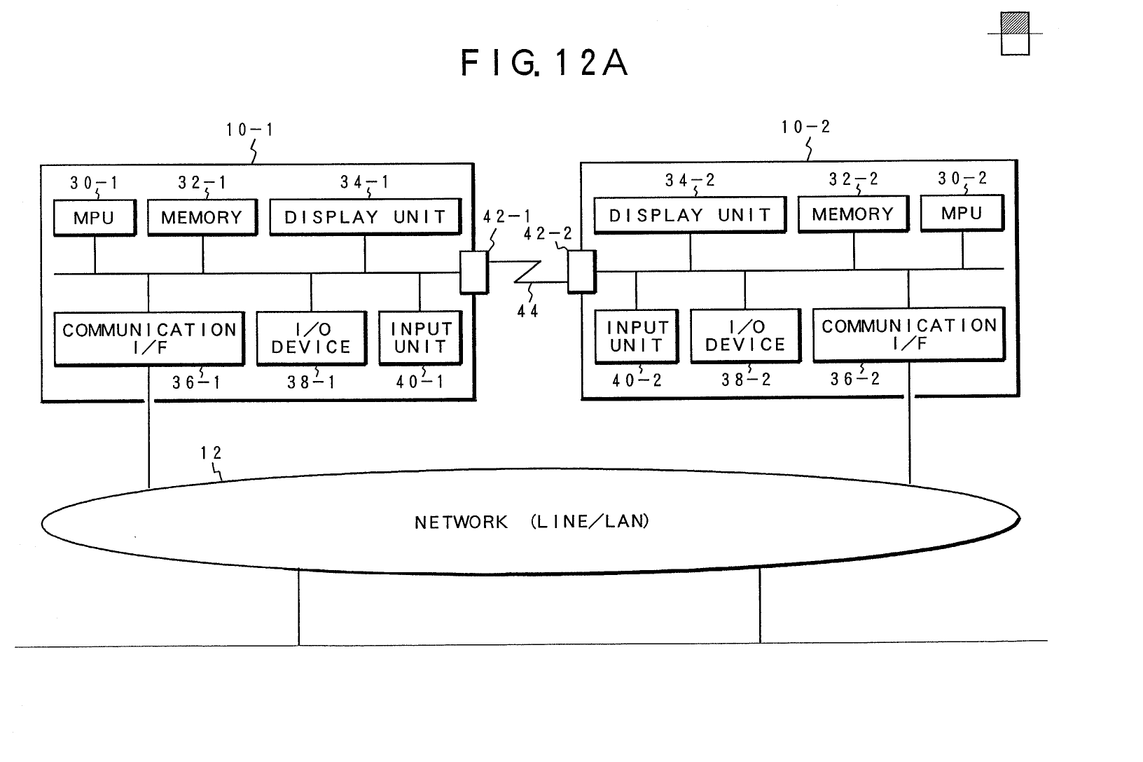

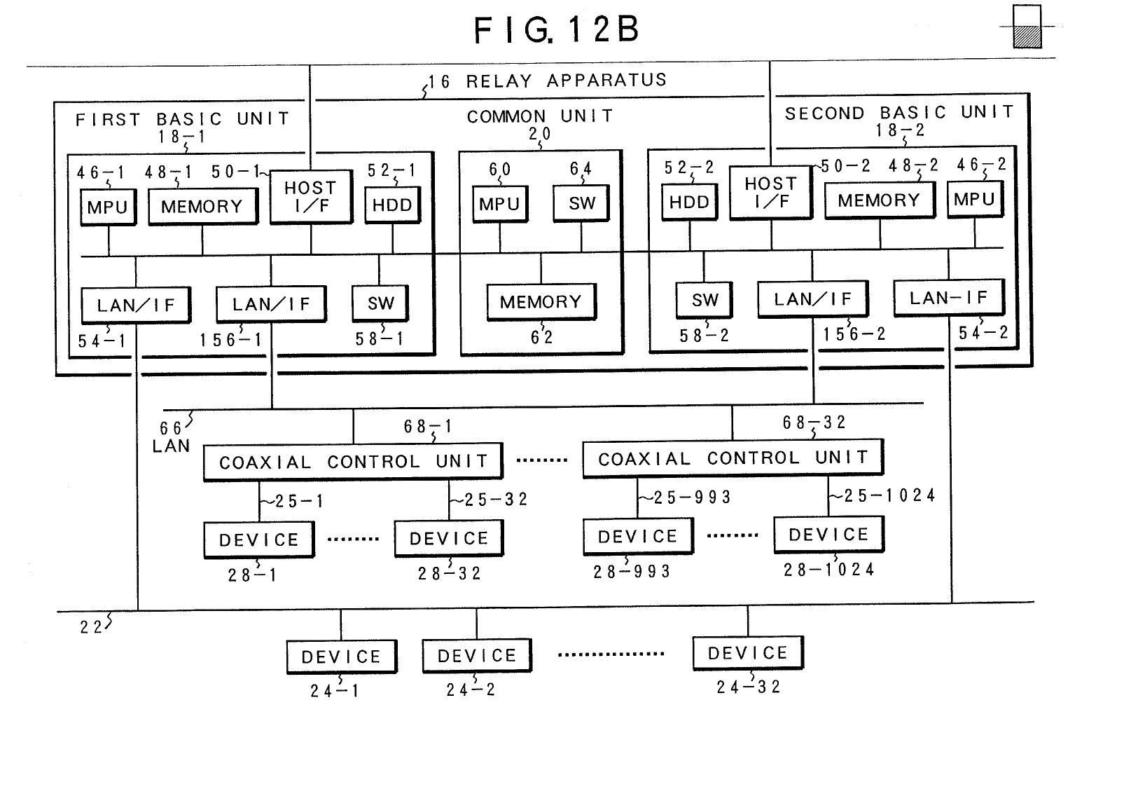

FIGS. 12A and 12B show another embodiment of a hardware construction of a computer system using the relay apparatus of the invention. This embodiment is characterized in that the connecting construction on the device side connected to the relay apparatus 16 by the coaxial cables is set to a connecting construction which can be easily expanded. Although the relay apparatus 16 and the host computers 101 and 10-2 are the same as those in the embodiment of FIGS. 6A and 6B, with respect to the devices 28-1 to 28-32 which are connected by the coaxial cables, in place of the coaxial I/F units 56-1 and 56-2 in FIGS. 6A and 6B, LAN interface units 156-1 and 156-2 are provided for the basic units 18-1 and 18-2 of the relay apparatus 16 and an LAN 66 is connected in common to the LAN I/F units 156-1 and 156-2. A coaxial control unit 68-1 is connected to the LAN 66. For example, the 32 devices 28-1 to 28-32 are connected to the coaxial control unit 68-1 by the coaxial cables 25-1 to 25-32. In such a device connection using the coaxial cables, for example, up to 32 coaxial control units 68-1 to 68-32 can be connected to the LAN 66. By newly adding coaxial control units, the devices on the coaxial cable connection can be easily got on a 32-device unit basis. In devices 28-1 to 28-1024 connected to the LAN 66 through the coaxial control units 68-1 to 68-32, each of the coaxial control units 68-1 to 68-32 is set to one group address and by using a corresponding table in which 32 intragroup addresses are set in the groups, a correspondence between the device number and the device address can be made.

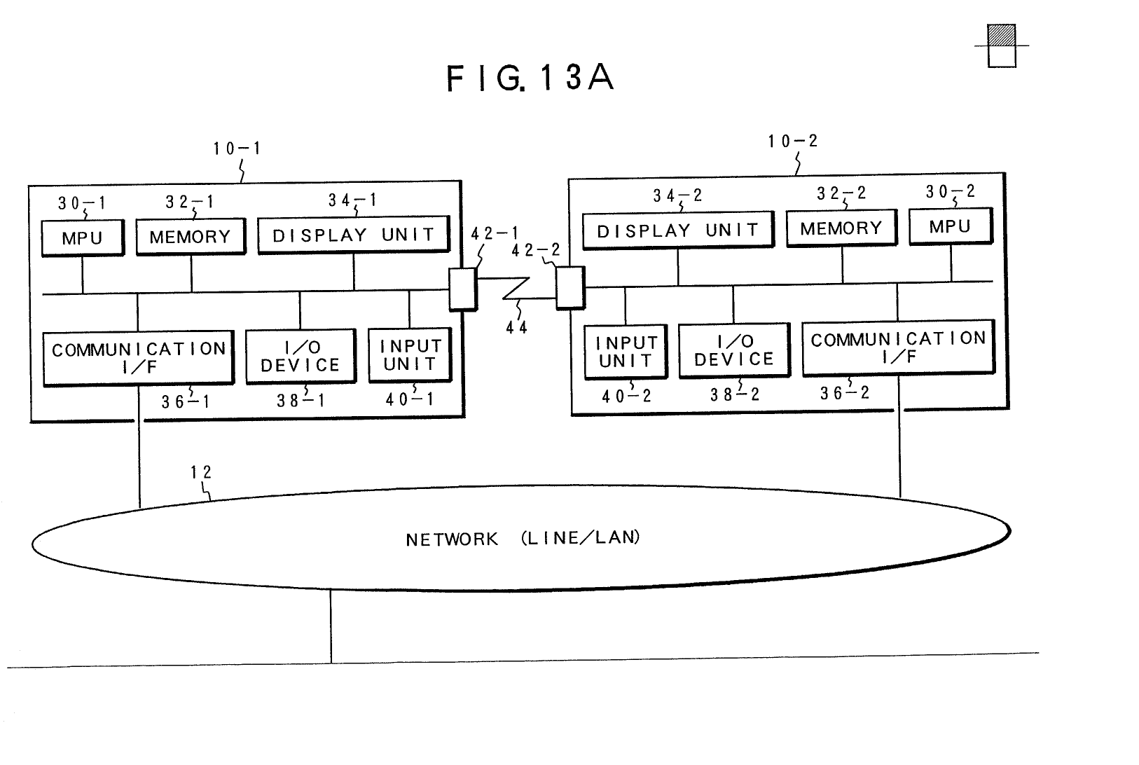

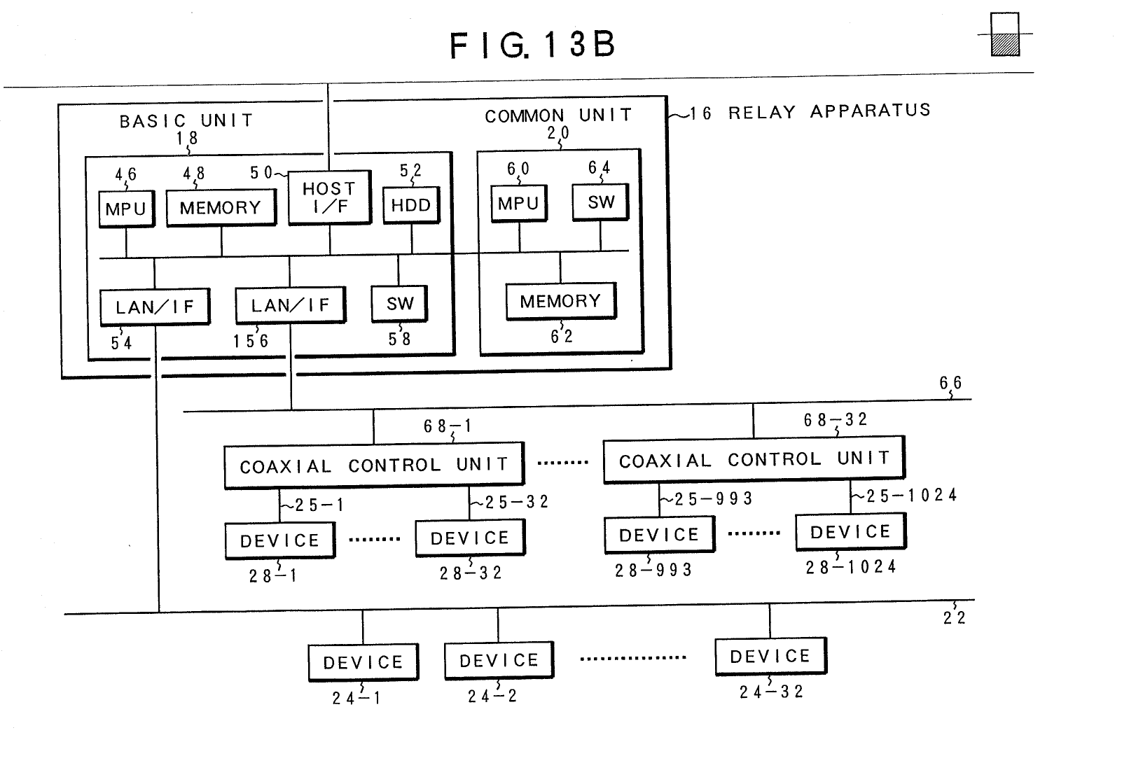

FIGS. 13A and 13B show a hardware construction of another embodiment of a relay apparatus of the invention. This embodiment is characterized in that only a basic unit 18 is substituted for the basic units of the relay apparatus 16 and the common unit 20 is provided for the basic unit 18. The devices 28-1 to 28-1024 can be connected to the common unit 20 by the coaxial control units 68-1 to 68-32 having an expanded construction in a manner similar to the embodiment of FIGS. 12A and 12B.

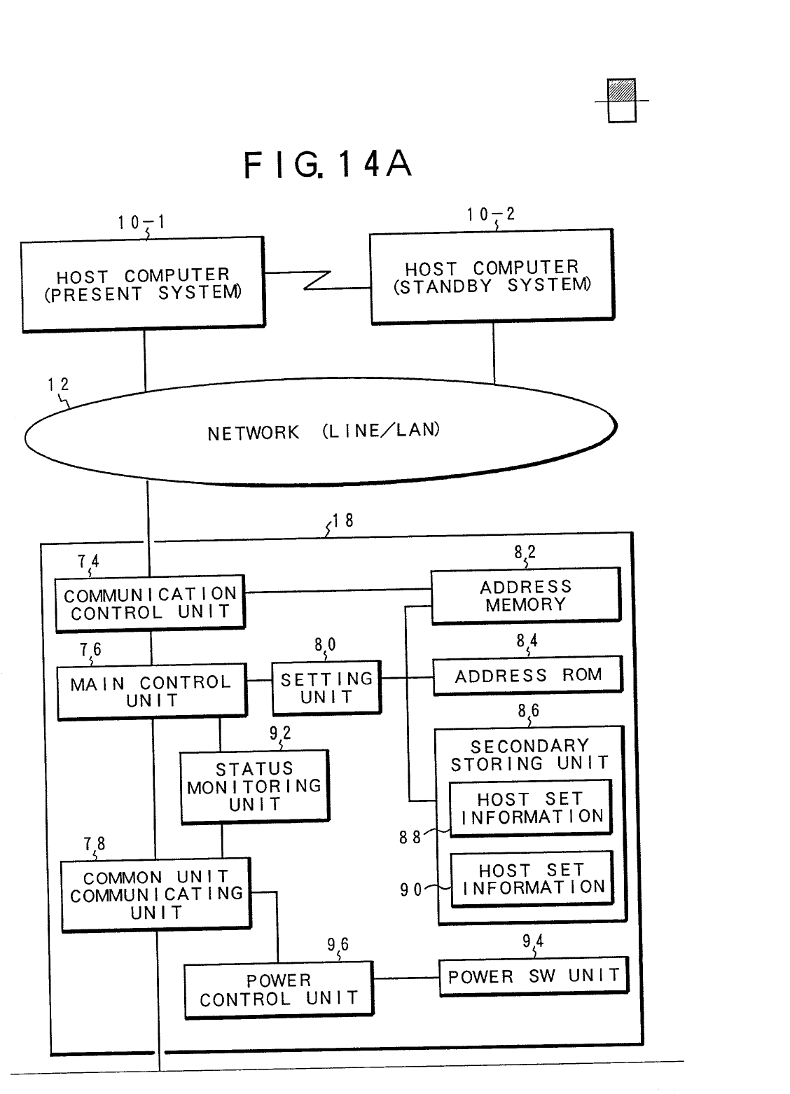

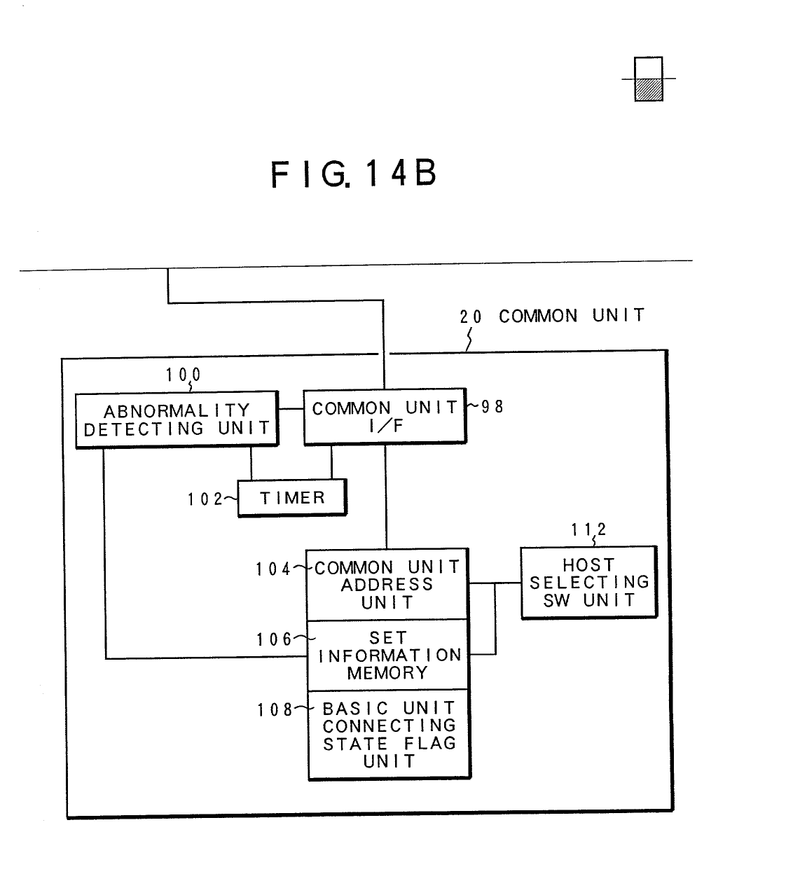

FIGS. 14A and 14B are block diagrams of a functional construction of the relay apparatus 16 in FIGS. 13A and 13B. In the relay apparatus 16, it is characterized in that the host computers 10-1 and 10-2 which are connected through the network 12 can be switched and selected by the host selecting switch unit 112 provided for the common unit 20. The basic unit 18 of the relay apparatus 16 has substantially the same construction as that of the embodiment of FIGS. 7A and 7B and the common unit 20 also has fundamentally the same construction except that the processing system selecting switch unit 110 is removed. Therefore, the basic unit 18 has fixedly been stored as processing system selection information into the set information memory 106. Thus, a control process regarding the host switching is substantially the same as that in FIGS. 11A to 11E. More specifically speaking, it means that if the second basic unit 18-2 is removed from the embodiment of FIGS. 7A and 7B, only the host selecting function is valid in the relay apparatus in this case. Consequently, in the case where the host computer sides which are connected through the network 12 have a multiple structure of the present system and standby system, the host on the connection destination side can be freely set and switched on the relay apparatus 16 side as necessary.

According to the invention as mentioned above, the relay apparatus is separated into the first basic unit and the second basic unit in correspondence to the duplex structure comprising the present system and the standby system on the host computer side, further, a common unit for performing the monitor of both of them and the switching upon occurrence of the abnormality is provided, and a common network address is set into each basic unit. Therefore, even if the relay apparatus has the duplex structure, it is sufficient to use only one network connection of the host computer by the line or LAN, a line efficiency is raised, and the line costs can be reduced. Even in the relay apparatus having the duplex structure when it is seen from the host computer of the present system and the host computer of the standby system, since there is no change in the network address, there is no need to be aware of the duplex structure of the relay apparatus when it is seen from the host computer. The data transmission is the same as that to the single relay apparatus. Thus, a communication control with the relay apparatus is simplified. The set information in the device corresponding table is not different every host computer and the same corresponding table can be used in common, so that it is simplified owing to it. The state of the basic unit of the present system is monitored by the common unit of the relay apparatus. When the abnormality is detected, the basic unit is automatically switched and shifted to the basic unit of the standby system. The switching upon occurrence of the abnormality can be promptly made. It is possible to avoid a situation such that a system stop is caused due to a device error on the host computer side during the switching operation. Since the network addresses in the two basic units having the duplex structure are transmitted from the common unit and set, even at the time of switching due to the occurrence of the fault, the network addresses can be certainly taken over and the relay control can be taken over. The relay control by the selected basic unit can be started by the manual activation in association with the selecting operation of the processing system in the common unit, so that the active maintenance at the time when the fault basic unit is repaired and recovered can be properly performed. By the activation of the basic unit based on the host selection of the common unit, the host computer serving as a connecting destination side of the activated basic unit can be selected and set. The host computer serving as a connecting destination side can be arbitrarily selected and set by the manual operation on the relay apparatus side in correspondence to the use form of the host computer. Further, as another embodiment of the invention, in case of using the structure of the relay apparatus in which the common unit is provided for the single basic unit, only the selecting function of the host computer in the common unit is validated. In this case, the relay control in which the host computer serving as a connecting destination side is arbitrarily selected by the selecting operation of the relay apparatus can be realized.

In the above embodiment, although both of the LAN connection and the connection using the coaxial cables have been used as a device connection to the relay apparatus, naturally, either one of or only one of the device connections can be also used as necessary. The invention also incorporates many modifications and variations without departing from the objects and advantages of the invention. Further, the invention is not limited by the numerical values shown in the above embodiments.

What is claimed is:

1. A relay apparatus which is connected to a host computer through a network and transmits data received from said host computer to a device, comprising:
a first basic unit into which a peculiar network address is set and which performs a relay control between said host computer and said device;
a second basic unit into which the same network address as that of said first basic unit is set and which performs a relay control between said host computer and said device; and
a common unit which makes one of said first basic unit and said second basic unit operative as a present system, monitors its status, and when an abnormality is detected during said monitoring operation, stops the basic unit of the present system and switches it to an operation of the basic unit of a standby system.

2. An apparatus according to claim 1, wherein each of said first and second basic units comprises:
a host communication control unit which is connected to said host computer and communicates therewith;
a device communication control unit which is connected to said device and communicates therewith;
a main control unit which performs a relay control for relaying the data received from said host computer to said device;
a setting unit which inputs set information necessary for the relay;
a secondary storing unit which stores resources including said set information, a control program, and character patterns from the host computer; and
a status monitoring unit which periodically notifies said common unit of a self status obtained as a self diagnosis result,
and said common unit comprises:
a common unit interface which is connected to said first basic unit and said second basic unit and communicates therewith;
a common unit address unit using a non-volatile memory which stores a common network address which is used for said first and second basic units; and
an abnormality detecting unit which, when the abnormality is detected from a status notice of the basic unit of the present system, instructs a power-off of the basic unit of the present system, thereafter, instructs a power-on of the basic unit of the standby system, and further, transmits the common network address stored in said common unit address unit to said host communication control unit of the basic unit of the standby system, thereby allowing said common network address to be taken over.

3. An apparatus according to claim 1, wherein said abnormality detecting unit of said common unit has a timer which sets a predetermined set time and is reactivated each time the periodic status notice from said basic unit is received and detects abnormality of the basic unit of the present system from time-out of said timer.

4. An apparatus according to claim 2, wherein if said common network address cannot be received from said common unit upon activation by a power-on, said host communication control unit of each of said first and second basic units reads out a common network address stored in a self address ROM and sets it.

5. An apparatus according to claim 2, wherein:
said common unit has a processing system selecting switch which selects the basic unit of the present system;
said common unit interface instructs a power-off to the basic unit of the present system and, thereafter, instructs a power-on to the basic unit selected by said processing system selecting switch in response to a notice of a power-on operation from said first basic unit or said second basic unit; and
each of said first and second basic units has a power control unit which notifies said common unit of the power-on operation at the time of a turn-on operation of a power switch, turns on a self power source when a power-on instruction is received from said common unit, and turns off the self power source when a power-off instruction is received from said common unit.

6. An apparatus according to claim 5, wherein
when the host computer of the present system and the host computer of the standby system are arranged through the network,
each of said first and second basic units stores each set information of said host computer of the present system and said host computer of the standby system,
said common unit has a host selecting switch which instructs a selection of the host computer of the present system or the host computer of the standby system and responds a selecting instruction of said host selecting switch in response to the notice of the power-on operation from said first basic unit or said second basic unit, and
the first basic unit or the second basic unit which received the power-on instruction from said common unit is initialized by the set information of said selected and instructed host computer and starts the relay operation.

7. An apparatus according to claim 2, wherein a plurality of devices such as displays and/or printers and the like are connected to said device communication control unit of each of said first and second basic units by a common local area network.

8. An apparatus according to claim 2, wherein a plurality of devices such as displays and/or printers and the like are individually connected to said device communication control unit of each of said first and second basic units by coaxial lines through a switching mechanism.

9. An apparatus according to claim 2, wherein a coaxial communication control unit which connects a plurality of devices such as displays and/or printers and the like by coaxial lines is connected to said device communication control unit of each of said first and second basic units through a common local area network.

10. A relay apparatus which is connected to a host computer of a present system or a host computer of a standby system through a network and transmits data received from said host computer in a connecting relation to a device, comprising:
a basic unit into which a peculiar network address is set and which performs a relay control between said host computer of the present system or said host computer of the standby system and the device; and
a common unit which instructs said basic unit to select the host computer of the present system or said host computer of the standby system and activates the selected host computer.

11. An apparatus according to claim 10, wherein
said basic unit comprises:
a power control unit which notifies said common unit of a power-on operation at the time of a turn-on operation of a power switch and, thereafter, turns on a power source;
a secondary storing unit which stores resources including each set information of said host computer of the present system and said host computer of the standby system;
a host communication control unit which is initialized by the set information of the host computer which was selected and instructed from said common unit, is connected to said host computer, and communicates therewith;
a device communication control unit which is connected to said device and communicates therewith; and
a main control unit which performs a relay control for relaying data received from said host computer to said device,
and said common unit comprises:
a host selecting switch which instructs a selection of the host computer of the present system or the host computer of the standby system; and
a common unit interface which is connected to said basic unit and communicates therewith and responds a selecting instruction of the host computer by said host selecting switch in response to a notice of a power-on operation from said basic unit.
